(19) United States
(12) Patent Application Publication
(10) Pub. No.: US 2025/0149199 A1
(43) Pub. Date: May 8, 2025

(54) IODINE CAPTURE AND ENCAPSULATION

(71) Applicant: Battelle Memorial Institute, Richland, WA (US)

(72) Inventors: Brian J. Riley, Kennewick, WA (US); Saehwa Chong, Rickland, WA (US)

(21) Appl. No.: 18/939,266

(22) Filed: Nov. 6, 2024

Related U.S. Application Data
(60) Provisional application No. 63/596,781, filed on Nov. 7, 2023.

(51) Int. Cl. G21F 9/02; B01D 53/68; B01D 53/82; B01J 20/22; B01J 20/28; B01J 20/32

(52) U.S. Cl. CPC G21F 9/02; B01D 53/685; B01D 53/82; B01J 20/223; B01J 20/28004; B01J 20/28016; B01J 20/321; B01J 20/3236; B01D 2253/202; B01D 2253/25; B01D 2257/202

(57) ABSTRACT

Implementations are described herein that include producing sorbents that include a polymeric material and a zero-valent metal. An amount of radioactive iodine can be captured using the sorbent to produce iodine-loaded sorbents. Additionally, the iodine-loaded sorbents can be encapsulated in one or more metallic materials.

### PRIORITY CLAIM

This application claims the benefit of priority to U.S. Provisional Application No. 63/596,781, filed on Nov. 7, 2023, and entitled “Iodine Capture and Encapsulation,” the contents of which are incorporated by reference herein in their entirety.

### STATEMENT AS TO RIGHTS TO DISCLOSURES MADE UNDER FEDERALLY-SPONSORED RESEARCH AND DEVELOPMENT

This invention was made with Government support under Contract DE-AC0576RL01830 awarded by the U.S. Department of Energy. The Government has certain rights in the invention.

### FIELD OF THE INVENTION

One or more implementations relate to the capture of radioactive iodine using metal and polymeric composites to produce an iodine-loaded sorbent and to encapsulate the iodine-loaded sorbent for storage of the radioactive iodine.

### BACKGROUND

Radioactive iodine can be produced through the processing of spent nuclear fuel. For example, iodine isotopes can be produced during nuclear fission reactions, such as ²³⁵U slow-neutron fission. In particular, ¹²⁹I and ¹³¹I can be released into aqueous phases and gas streams present in nuclear fuel treatment processes. In some cases, radioactive iodine can be found in dissolver off-gas, ventilation off-gas, nuclear cell off-gas, and melter off-gas. Radioactive iodine released from nuclear fission reactions is typically captured and immobilized for long-term storage due to the relatively long half-life of ¹²⁹I.

### BRIEF DESCRIPTION OF THE DRAWINGS

FIG. 1 illustrates a framework to capture and encapsulate iodine from a waste stream generated by a nuclear fission process, in accordance with one or more examples.

FIG. 2 illustrates a process to produce compositions for the capture of iodine that include polymer-metal composite materials, in accordance with one or more examples.

FIG. 3 illustrates a process to capture iodine using polymer-metal composite materials and to remove a portion of the polymeric material from the polymer-metal composite, in accordance with one or more examples.

FIG. 4 illustrates a process to encapsulate and store iodine that has been captured in a polymer-metal composite, in accordance with one or more examples.

FIG. 5 illustrates a flow diagram of a process to capture and store iodine produced in conjunction with a nuclear fission process, in accordance with one or more examples.

FIG. 6 includes optical images of full composite beads of Ag-polyacrylonitrile (PAN), (Bi-PAN, Cu-PAN, and Sn-PAN and SEM micrographs of internal surfaces of as-made metal-PAN composites.

FIG. 7 includes pictures of iodine-loaded samples including metal particles and metal-PAN composites including those with Ag, Bi, Cu, and Sn. Image insets show higher-resolution images of a single metal-PAN composite for each sample. SEM micrographs of metal-PAN composites loaded with iodine for 48 hours taken at two different magnifications including Ag-PAN+I, Bi-PAN+I, Cu-PAN+I, and Sn-PAN+I.

FIG. 8A includes a summary of Qₑ (gram iodine/gram sorbent) and qₑ (1000·milligram iodine/gram sorbent) data and FIG. 8B shows conversion % for both metal-PAN composites and the metal particles for the 48-hour experiments.

FIGS. 9A-9D include XRD patterns and phases of Ag, Bi, Cu, and Sn metal-PAN composites and metal particles before and after iodine loading at 120±1° C. for 48 hours.

FIG. 10A includes XRD patterns showing conversion of Bi⁰ to BiI₃ phases, FIG. 10B includes phase conversion % (C % m) based on iodine mass data, FIG. 10C includes Qₑ (m_{I}/mₛ) data, FIG. 10D includes XRD phase distribution for Bi-PAN composites, and FIG. 10E includes XRD phase distribution for Bi-Particles.

FIGS. 11A-C include data comparisons for Bi-PAN composites loaded with iodine including XAS data including measured and calculated datasets for XANES at 24 h, 48 h, and 72 h of iodine exposure time as well as showing the fluctuations in the intensities between samples in the EXAFS region. Also shown in FIGS. 11D-F are mass fractions of components in the Bi-PAN+I including showing mf_{PAN}, mf_{Bi}, mf_{I}, mf_{Bi,r}, and mf_{BI3} in the iodine-loaded samples and a comparison between the BiI₃ mass fractions in the 24-h, 48-h, and 72-h samples calculated by mass changes and XANES fitting.

### DETAILED DESCRIPTION

Various technologies have been developed to capture and store radioactive iodine released in relation to nuclear fission processes, such as nuclear fuel reprocessing, salt-fueled molten salt reactor operations, waste treatment, and unexpected releases of nuclear fission byproducts. For examples, iodine absorbers that include metal-exchanged porous sorbents, have been used to absorb radioactive iodine. Additionally, chalcogels, porous organic polymers, and metal-organic frameworks have been proposed for the capture of iodine generated during fission of nuclear fuels. These sorbents can capture iodine using chemisorption, physisorption, or a combination thereof. In some specific examples, existing techniques for capturing and storing radioactive iodine include metal-exchanged zeolite sorbents, Ag-loaded aerogels, Ag-loaded xerogels, and Sn-based chalcogel sorbents. In at least some cases, the gel-based sorbents can have a greater amount of iodine loading capacity than zeolites, possibly due to the higher specific surface areas of the gel-based sorbents, but more likely due to the higher metal content in the gels compared to zeolites. Additionally, metal-based sorbents including Ag- or Bi-functionalized Ni-metal foams have been used to capture radioactive iodine. These metal-based foams can provide porous metal support with active metal sites using metals with a relatively high iodine affinity and low metal-iodide leach rates. Radioactive iodine sorbents can be used in scrubbing processes that can remove gaseous iodine from one or more waste streams. In at least some scenarios, sorbent beds can be used to capture iodine from nuclear processing waste streams.

The iodine sorbents are typically not a final storage form. The long-term storage forms for the iodine sorbents have relatively low porosity and are comprised of materials that prevent transport of the radioiodine isotopes through the environment. In some cases, iodine has been incorporated into glass structures formed from borosilicates, silver oxides, phosphates, lead, and/or non-oxide chalcogenides (e.g., S, Se, and/or Te). Additionally, captured iodine can be encapsulated in glass composite materials that include a crystalline component, such as a ceramic material, contained in a glass matrix. Glass ceramics can also be formed by combining an iodine-containing material with a glass binder. Further, cement waste forms can be used to encapsulate radioactive iodine captured by a number of sorbents.

The techniques, processes, methods, compounds, and compositions described herein are directed to the capture of radioactive iodine using polymer-metal composite materials. In one or more examples, the polymer metal composite materials can encapsulate a ceramic material, such as a metal-iodide. In these situations, the waste forms can be referred to as polymer-ceramic-metal composites or “polycermets.” In other examples, waste forms that comprise the encapsulation of metal-iodides in a metal matrix including a polymeric compound can also be referred to as polymer-halide-metal composites or “polyhalmets.” In addition, implementations described herein include the encapsulation of iodine-loaded sorbents using ceramic-metal waste forms that can be produced using relatively low temperatures. In various examples, the ceramic metal waste forms can be referred to as ceramic-metal composites or “cermets.” The implementations described herein are also directed to the encapsulation of iodine-loaded sorbents that provides a relatively low volume, metallic waste form that includes secondary barriers to iodine released into the environment.

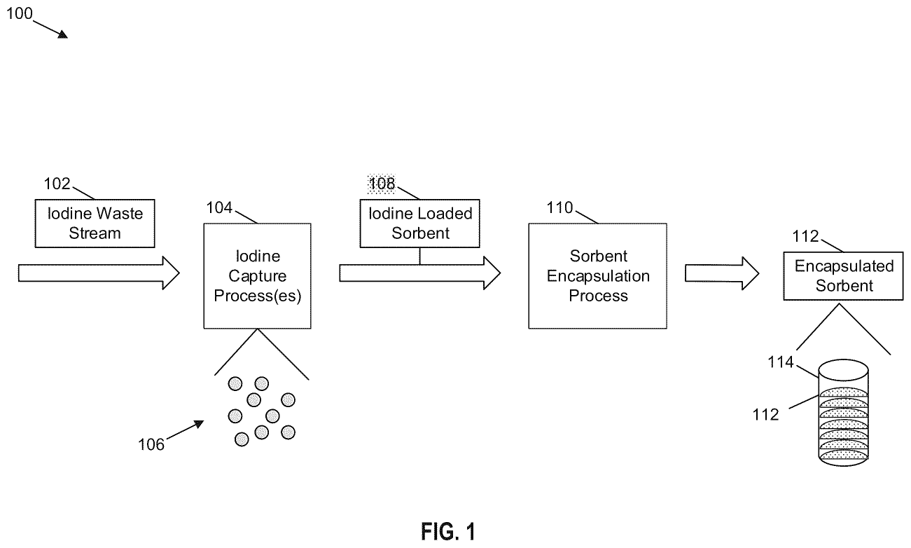

FIG. 1 illustrates a framework 100 to capture and encapsulate iodine from a waste stream generated by a nuclear fission process, in accordance with one or more examples. The framework 100 can include an iodine waste stream 102. The iodine waste stream 102 can include radioactive iodine that is produced during the processing of spent fuel from nuclear fission reactions. For example, iodine isotopes can be produced as products of ²³⁵U slow-neutron fission, fast-neutron fission, and ²³⁹Pu fission. To illustrate, ¹²⁷I, ¹²⁹I, and ¹³¹I can be present in waste streams of nuclear fission reactions. In various examples, iodine isotopes can comprise less than 1% by weight of the fission products of a nuclear fuel. Iodine present in aqueous phases and gaseous phases of the nuclear fission waste streams can be released and be a component of off-gas streams of a number of processes involved in the reprocessing of used nuclear fuel, such as the fuel off-gas, the dissolver off-gas, the melter off-gas, and/or the ventilation off-gas. In various examples, the iodine waste stream can comprise gaseous radioactive iodine included in at least one of the following: fuel off-gas, the dissolver off-gas, the melter off-gas, or the ventilation off-gas.

The framework 100 can also include one or more iodine capture processes 104. The one or more iodine capture processes 104 can include contacting the iodine waste stream 102 with one or more compositions that have a capacity to capture the radioactive iodine present in the iodine waste stream 102. In one or more examples, the one or more iodine capture processes 104 can include one or more beds, one or more columns, or one or more filters that include one or more sorbents 106 that can capture radioactive iodine present in the iodine waste stream 102. The one or more sorbents 106 used in the one or more iodine capture processes 104 can include at least one of zeolites, aerogels, xerogels, chalcogels, porous organic polymers, metal-chalcogen-containing polymer composites, or metal-organic compounds. For example, the one or more sorbents 106 can include Ag-zeolites, Ag-loaded aerogels, Ag-loaded xerogels, Sn-based chalcogels, or one or more combinations thereof. In one or more additional examples, the one or more sorbents 106 can include at least one of Ag-loaded alumina beads or Ag-loaded silica beads. In one or more further examples, the one or more sorbents used in the one or more iodine capture processes 104 can include zero-valent metals that have an affinity for iodine gas. Iodine gas as used herein can correspond to I₂(g). Radioactive iodine can be absent from the one or more sorbents 106 prior to the one or more sorbents 106 being contacted by the iodine waste stream 102.

In one or more illustrative examples, the one or more sorbents 106 can include metal particles comprised of at least one of Ag⁰, Bi⁰, Cu⁰, or Sn⁰. In one or more additional illustrative examples, the one or more sorbents 106 can include metal particles comprised of at least one of Ag⁰, Bi⁰, Cu⁰, or Sn⁰ that are disposed in a polymeric substrate. In various examples, the one or more sorbents 106 can include at least one of Ag⁰, Bi⁰, Cu⁰, or Sn⁰ disposed in a substrate that includes a polyacrylonitrile. In at least some examples, the polyacrylonitrile that is included in the one or more sorbents 106 can have an amorphous density from about 0.9 g/cm³ to about 1.3 g/cm³ or from about 1.0 g/cm³ to about 1.2 g/cm³. Additionally, the polyacrylonitrile that is included in the one or more sorbents 106 can have a glass transition temperature from about 90° C. to about 110° C. or from about 95° C. to about 105° C. In still other examples, the polyacrylonitrile that is included in the one or more sorbents 106 can have a decomposition temperature from about 165° C. to about 185° C. or from about 170° C. to about 180° C. The properties of the polyacrylonitrile included in the one or more sorbents 106 can correspond to those measured by Vatanpour, V, ME Pasaoglu, B Kose-Mutlu, and I Koyuncu. 2023. “Polyacrylonitrile in the Preparation of Separation Membranes: A Review.” Industrial & Engineering Chemistry Research 62(17):6537-58.

In one or more examples, the one or more sorbents 106 can include at least about 50% by mass, at least about 55% by mass, at least about 60% by mass, at least about 65% by mass, at least about 70% by mass, at least about 75% by mass, at least about 80% by mass, at least about 85% by mass, at least about 90% by mass, or at least about 95% by mass of a zero-valent metal comprising at least one of Ag⁰, Bi⁰, Cu⁰, or Sn⁰. In one or more illustrative examples, the one or more sorbents can include from about 50% by mass to about 95% by mass, from about 60% by mass to about 90% by mass, from about 70% by mass to about 80% by mass, from about 80% by mass to about 90% by mass, or from about 75% by mass to about 85% by mass of a zero-valent metal comprising Ag⁰, Bi⁰, Cu⁰, or Sn⁰. Additionally, the one or more sorbents can include at least about 5% by mass of a polyacrylonitrile, at least about 10% by mass of a polyacrylonitrile, at least about 15% by mass of a polyacrylonitrile, at least about 20% by mass of a polyacrylonitrile, at least about 25% by mass of a polyacrylonitrile, at least about 30% by mass of a polyacrylonitrile, at least about 35% by mass of a polyacrylonitrile, at least about 40% by mass of a polyacrylonitrile, at least about 45% by mass of a polyacrylonitrile, or at least about 50% by mass of a polyacrylonitrile. In one or more additional illustrative examples, the one or more sorbents can include from about 5% by mass to about 50% by mass, from about 10% by mass to about 40% by mass, from about 20% by mass to about 30% by mass, from about 25% by mass to about 35% by mass, or from about 15% by mass to about 25% by mass of a polyacrylonitrile. In one or more further illustrative examples, the one or more sorbents 106 can include from about 60% by mass to about 90% by mass of a zero-valent metal comprising Ag⁰, Bi⁰, Cu⁰, or Sn⁰ and from about 10% by mass to about 40% by mass of a polyacrylonitrile. In still other illustrative examples, the one or more sorbents 106 can include from about 70% by mass to about 80% by mass of a zero-valent metal comprising Ag⁰, Bi⁰, Cu⁰, or Sn⁰ and from about 20% by mass to about 30% by mass of a polyacrylonitrile.

In various examples, the one or more sorbents 106 can be in the shape of beads. In one or more examples, the beads can have ellipsoidal shapes. In at least some examples, the one or more sorbents 106 can be in the shape of beads having diameters from about 1.5 mm to about 5 mm, from about 2 mm to about 4 mm, from about 2 mm to about 3 mm, from about 3 mm to about 4 mm, or from about 2.5 mm to about 3.5 mm.

Iodine-loaded sorbent 108 can be produced by the one or more iodine capture processes 104. The iodine-loaded sorbent 108 can include the one or more sorbents 106 after capturing radioactive iodine from the iodine waste stream 102. In at least some examples, the amount of iodine captured by the iodine-loaded sorbent 108 can be expressed as the conversion percentage (C % m) based on mass change data as described in Chong et al., Iodine Capture with Metal-Functionalized Polyacrylonitrile Composite Beads Containing Ag⁰, Bi⁰, Cu⁰, or Sn⁰ Particles, ACS Applied Polymer Materials 2022 4 (12), 9040-9051. The conversion percentage with respect to the iodine-loaded sorbent 108 can be at least 20%, at least 30%, at least 40%, at least 50%, at least 60%, at least 70%, at least 80%, at least 90%, at least 95%, at least 97%, or at least 99%. In various examples, the conversion percentage with respect to the iodine-loaded sorbent 108 can be from about 20% to about 99%, from about 30% to about 90%, from about 40% to about 80%, from about 50% to about 70%, from about 30% to about 50%, from about 70% to about 90%, from about 80% to about 90%, or from about 90% to about 99%.

In one or more illustrative examples, the one or more sorbents 106 can comprise an Ag⁰-polyacrylonitrile composite and the conversion percentage can be from about 60% to about 95%, from about 70% to about 90%, or from about 80% to about 90%. In one or more additional illustrative examples, the one or more sorbents 106 can comprise a Cu⁰-polyacrylonitrile composite and the conversion percentage can be from 70% to 99%, from 80% to 99%, or from 90% to 99%. In one or more further illustrative examples, the one or more sorbents 106 can comprise a Bi⁰-polyacrylonitrile composite and the conversion percentage can be from about 20% to about 50% or from about 30% to about 40%. In still other illustrative examples, the one or more sorbents 106 can comprise a Sn⁰-polyacrylonitrile composite and the conversion percentage can be from about 30% to about 70%, from about 40% to about 60%, or from about 50% to about 60%.

In one or more examples, metallic materials included in the one or more sorbents 106 can react with iodine present in the iodine waste stream 102 to produce one or more metal-iodide compounds that are included in the iodine-loaded sorbent 108. For example, Bi included in the one or more sorbents 106 can react with iodine include in the iodine waste stream 102 to form at least one of BiI₃ or BiOI in the iodine-loaded sorbent 108. Additionally, Ag included in the one or more sorbents 106 can react with iodine present in the iodine waste stream 102 to form AgI in the iodine-loaded sorbent 108. Further, Cu present in the one or more sorbents 106 can react with iodine included in the iodine waste stream 102 to form CuI in the iodine-loaded sorbent and Sn present in the one or more sorbents 106 can react with iodine present in the iodine waste stream 102 to form at least one of SnI₂ or SnI₄ in the iodine-loaded sorbent 108. In still other examples, Pb included in the one or more sorbents 106 can react with iodine in the iodine waste stream 102 to form PbI₂ in the iodine-loaded sorbent.

The framework 100 can also include a sorbent encapsulation process 110. The sorbent encapsulation process 110 can include encapsulating the iodine-loaded sorbent 108 in a medium that minimizes or prevents release of radioactive iodine into an environment. In one or more examples, the sorbent encapsulation process 110 can include encapsulating the iodine-loaded sorbent 108 in one or more metals. In at least some examples, metal iodides present in the iodine-loaded sorbent 108 can be encapsulated in the one or more metals. For example, the sorbent encapsulation process 110 can include encapsulating the iodine-loaded sorbent 108 in a Bi metallic material. Additionally, the sorbent encapsulation process 110 can include encapsulating the iodine-loaded sorbent 108 in a Sn metallic material. Further, the sorbent encapsulation process 110 can include encapsulating the iodine-loaded sorbent 108 in a Bi—Sn alloy metallic material. In still other examples, the sorbent encapsulation process 110 can include encapsulating the iodine-loaded sorbent 108 in a Bi—Pb alloy metallic material.

The sorbent encapsulation process 110 can be performed at temperatures below melting and decomposition temperatures of metal iodides formed during the one or more iodine capture processes 104. For example, melting or decomposition temperatures of metal iodides produced by the one or more iodine capture processes 104 can be at least 400° C. To illustrate, a decomposition temperature of AgI can be about 558° C., a melting or decomposition temperature of CuI can be about 606° C., a melting or decomposition temperature of BiI₃ can be about 409° C., and a melting temperature of PbI₂ can be about 410° C. In one or more additional examples, the sorbent encapsulation process 110 can be performed at temperatures below decomposition temperatures and/or melting temperatures of other components included in the iodine-loaded sorbent 108, such as one or more polymeric materials included in the iodine-loaded sorbent 108. In one or more illustrative examples, the sorbent encapsulation process 110 can be performed at temperatures below a melting temperature of polyacrylonitrile of about 317° C. In still other examples, the sorbent encapsulation process 110 can be performed using a range of pressures. In at least some scenarios, the sorbent encapsulation process 110 can be performed at pressures from no greater than 5 megapascals (MPa) to pressures no greater than 700 MPa. In one or more additional examples, the sorbent encapsulation process 110 can include at least one of a cold press and sinter operation, hot uniaxial press operations including spark plasma sintering, or hot isostatic press operations.

The sorbent encapsulation process 110 can produce an encapsulated sorbent 112. In one or more examples, the encapsulated sorbent 112 can be stored in a container 114. In various examples, the sorbent encapsulation process 110 can be performed while the iodine-loaded sorbent 108 is present in the container 114 and the container 114 can be part of the encapsulated sorbent 112. To illustrate, the container 114 can be comprised of a Bi metallic material, a Sn metallic material, a Pb metallic material, a Bi—Sn alloy metallic material, or a Bi—Pb alloy metallic material.

In at least some examples, the encapsulated sorbent 112 can have a higher density than the iodine-loaded sorbent 108. In one or more illustrative examples, the encapsulated sorbent 112 can be characterized by an amount of open porosity of the encapsulated sorbent 112. For example, the encapsulated sorbent 112 can have an open porosity of no greater than about 3.0% by volume pores, no greater than 2.8% by volume pores, no greater than 2.6% by volume pores, no greater than 2.4% by volume pores, no greater than 2.2% by volume pores, no greater than 2.0% by volume pores, no greater than 1.8% by volume pores, no greater than 1.6% by volume pores, no greater than 1.4% by volume pores, no greater than 1.2% by volume pores, no greater than 1.0% by volume pores, no greater than 0.8% by volume pores, no greater than 0.6% by volume pores, or no greater than 0.4% by volume pores. In one or more additional illustrative examples, the encapsulated sorbent 112 can have an open porosity from about 0.4% by volume pores to about 3.0% by volume pores, from about 0.6% by volume pores to about 2.4% by volume pores, from about 1.0% by volume pores to about 2.0% by volume pores, from about 0.8% by volume pores to about 1.6% by volume pores, from about 0.4% by volume pores to about 1.2% by volume pores, or from about 1.4% by volume pores to about 2.2% by volume pores.

In one or more examples, the encapsulated sorbent 112 can be formed into a shape by the sorbent encapsulation process 110. For example, the sorbent encapsulation process 110 can produce encapsulated sorbents 112 in the shape of pellets and the pellets can be stored in the container 114. In various examples, the shape of the encapsulated sorbent 112 can be based on a shape of a die used in the sorbent encapsulation process 110. In one or more illustrative examples, the encapsulated sorbent 112 can have diameters from 2 mm to 20 mm or from 5 mm to 10 mm and heights from 1 mm to 5 mm or from 2 mm to 3 mm.

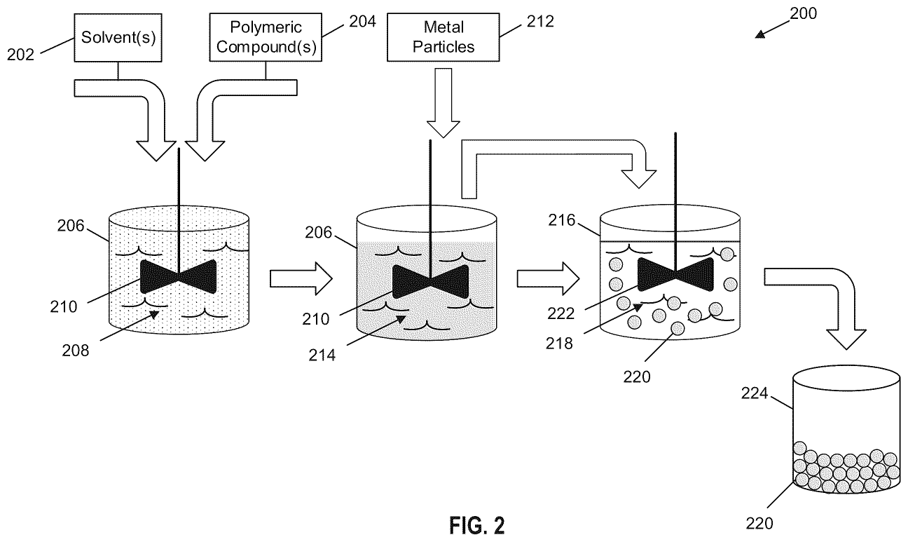

FIG. 2 illustrates a process 200 to produce compositions for the capture of iodine that include polymer-metal composite materials, in accordance with one or more examples. The process 200 can include adding one or more solvents 202 and one or more polymeric compounds 204 to a first container 206 to produce a first solution 208. In various examples, a mixing device 210 can be coupled to or otherwise associated with the first container 206. The mixing device 210 can include at least one of a mechanical mixing device or a sonic mixing device. In one or more illustrative examples, the mixing device can include a mechanical stir bar, a paddle, or a sonicator. The mixing device 210 can provide mixing of the one or more solvents 202 and the one or more polymeric compounds 204. In at least some examples, the mixing device 210 can mix the one or more solvents 202 and the one or more polymeric compounds 204 to dissolve the one or more polymeric compounds 204 in the one or more solvents 202. In one or more additional illustrative examples, the mixing device 210 can operate to produce a homogeneous first solution 208. In one or more further illustrative examples, the mixing device 210 can operate at speeds from about 50 revolutions per minute (RPM) to about 1000 RPM, from about 100 RMP to about 900 RPM, from about 200 RPM to about 800 RPM, from about 300 RPM to about 700 RPM, or from about 400 RPM to about 600 RPM. In still other illustrative examples, the mixing device 210 can operate from about 5 minutes to about 30 minutes to produce the first solution 208, from about 10 minutes to about 20 minutes to produce the first solution 208, or from about 12 minutes to about 18 minutes to produce the first solution 208.

The one or more solvents 202 can include one or more organic solvents. For example, the one or more solvents 202 can include dimethyl sulfoxide (DMSO). In addition, the one or more solvents 202 can include dimethyl acetamide. Further, the one or more solvents 202 can include dimethyl formamide. In still other examples, the one or more solvents 202 can include ethyl carbonate. In various examples, the one or more solvents 202 can include sulfolane. In one or more implementations, the one or more solvents 202 can include N-methylpyrrolidone. In one or more illustrative examples, the one or more solvents 202 can include at least one of DMSO, dimethyl acetamide, dimethyl formamide, ethyl carbonate, sulfolane, or N-methylpyrrolidone. In one or more additional illustrative examples, the one or more polymeric compounds 204 can include polyacrylonitrile. In at least some examples, the one or more polymeric compounds 204 can include polyacrylonitrile fibers having lengths from about 20 mm to about 100 mm.

The process 200 can also include adding metal particles 212 to the first solution 208 in the first container 206 to produce a second solution 214. The metal particles 212 can be suspended in the second solution 214. In one or more examples, the mixing device 210 can operate at speeds from about 50 revolutions per minute (RPM) to about 1000 RPM, from about 100 RMP to about 900 RPM, from about 200 RPM to about 800 RPM, from about 300 RPM to about 700 RPM, or from about 400 RPM to about 600 RPM to produce the second solution 214. In various examples, the mixing device 210 can operate to mix the metal particles 212 with the first solution 208 until the second solution 214 is produced with the metal particles 212 being homogeneously suspended in the second solution 214. In at least some examples, the mixing device 210 can operate from about 2 minutes to about 15 minutes, from about 3 minutes to 10 minutes, or from about 4 minutes to about 8 minutes to produce the second solution 214.

In one or more examples, the ratio of volume of solvent to mass of polymeric compound can depend on an amount of metal particles 212 added to produce the second solution 214. To illustrate, as an amount of metal particles 212 added to produce the second solution 214 decreases, the amount of the one or more solvents 202 present in the first solution 208 and the second solution 214 can also decrease. In various examples, the amounts of the one or more solvents 202, the amounts of the one or more polymeric compounds 204, and the amounts of the metal particles 212 used in the process 200 can vary based on producing the second solution 214 having a viscosity that makes the second solution 214 amenable to being withdrawn from the first container 206 and deposited into a second container 216 containing a third solution 218 to produce sorbent fragments 220. For example, in situations where an amount of the one or more solvents 202 used in the process 200 is beyond an upper threshold amount with respect to the amount of one or more polymeric compounds 204 and the amount of the metal particles 212, the viscosity of the second solution 214 can be too low. In these instances, the sorbent fragments 220 may lack structural integrity and be unsuitable for use in capturing radioactive iodine from nuclear fission waste streams. In other examples, in scenarios where an amount of the one or more polymeric compounds 204 used in the process 200 is beyond an upper threshold amount with respect to the amount of the one or more solvents 202 and the metal particles 212, the viscosity of the second solution 214 can be too high. In these situations, the second solution 214 may be too viscous to achieve proper mixing of the metal particles 212 with the one or more solvents 202 and the one or more polymeric compounds 204 such that the metal particles 212 may not be suspended in the second solution 214. As a result, the sorbent fragments 220 may be unable to cohesively form within the second container 216.

In at least some examples, the viscosity of the second solution 214 can be modified based on the temperature of the second solution 214. In one or more illustrative examples, the viscosity of the second solution 214 can be decreased by lowering the temperature of the second solution 214. For example, the container 216 can be disposed in an ice bath to lower the temperature of the second solution 214. Additionally, the viscosity of the second solution 214 can be decreased by increasing the temperature of the second solution 214. To illustrate, heat can be applied to the container 206 to heat the second solution 214.

The amount of the one or more solvents 202 present in the first solution 208 with respect to an amount of the one or more polymeric compounds 204 present in the first solution 208 can be expressed as a ratio of volume of solvent to mass of polymeric compound. In one or more examples, the ratio of volume of solvent to mass of polymeric compound can be from about 10 mL solvent/1 g polymeric compound to about 18 g solvent/1 g polymeric compound. In one or more additional examples, the ratio of volume of solvent to mass of polymeric compound can be from about 12 mL solvent/1 g polymeric compound to about 16 mL solvent/1 g polymeric compound. In one or more further examples, the ratio of volume of solvent to mass of polymeric compound can be from about 14 mL solvent/1 g polymeric compound to about 15 mL solvent/1 g polymeric compound.

The amount of metal particles 212 present in the second solution 214 can be at least 50% by mass with respect to the mass of the one or more polymeric compounds 204 and the mass of the metal particles 212 combined, at least about 60% by mass with respect to the mass of the one or more polymeric compounds 204 and the mass of the metal particles 212 combined, at least about 70% by mass with respect to the mass of the one or more polymeric compounds 204 and the mass of the metal particles 212 combined, or at least about 80% by mass with respect to the mass of the one or more polymeric compounds 204 and the mass of the metal particles 212 combined. In one or more additional examples, the amount of metal particles 212 present in the second solution 214 can be no greater than about 95% by mass with respect to the mass of the one or more polymeric compounds 204 and the mass of the metal particles 212 combined, no greater than about 92% by mass with respect to the mass of the one or more polymeric compounds 204 and the mass of the metal particles 212 combined, no greater than about 90% by mass with respect to the mass of the one or more polymeric compounds 204 and the mass of the metal particles 212 combined, no greater than about 88% by mass with respect to the mass of the one or more polymeric compounds 204 and the mass of the metal particles 212 combined, or no greater than about 85% by mass with respect to the mass of the one or more polymeric compounds 204 and the mass of the metal particles 212 combined. In one or more illustrative examples, the amount of metal particles 212 present in the second solution 214 can be from about 50% by mass to about 95% by mass with respect to the mass of the one or more polymeric compounds 204 and the mass of the metal particles 212 combined, from about 60% by mass to about 90% by mass with respect to the mass of the one or more polymeric compounds 204 and the mass of the metal particles 212 combined, from about 70% by mass to about 90% by mass with respect to the mass of the one or more polymeric compounds 204 and the mass of the metal particles 212 combined, or from about 70% by mass to about 80% by mass with respect to the mass of the one or more polymeric compounds 204 and the mass of the metal particles 212 combined.

The amount of the one or more polymeric compounds 204 present in the second solution 214 can be no greater than about 50% by mass with respect to the mass of the one or more polymeric compounds 204 and the mass of the metal particles 212 combined, no greater than about 40% by mass with respect to the mass of the one or more polymeric compounds 204 and the mass of the metal particles 212 combined, no greater than about 30% by mass with respect to the mass of the one or more polymeric compounds 204 and the mass of the metal particles 212 combined, or no greater than about 20% by mass with respect to the mass of the one or more polymeric compounds 204 and the mass of the metal particles 212 combined. In one or more additional examples, the amount of the one or more polymeric compounds 204 present in the second solution 214 can be at least about 5% by mass with respect to the mass of the one or more polymeric compounds 204 and the mass of the metal particles 212 combined, at least about 8% by mass with respect to the mass of the one or more polymeric compounds 204 and the mass of the metal particles 212 combined, at least about 10% by mass with respect to the mass of the one or more polymeric compounds 204 and the mass of the metal particles 212 combined, at least about 12% by mass with respect to the mass of the one or more polymeric compounds 204 and the mass of the metal particles 212 combined, or at least about 15% by mass with respect to the mass of the one or more polymeric compounds 204 and the mass of the metal particles 212 combined. In one or more illustrative examples, the amount of the one or more polymeric compounds 204 present in the second solution 214 can be from about 5% by mass to about 50% by mass with respect to the mass of the one or more polymeric compounds 204 and the mass of the metal particles 212 combined, from about 10% by mass to about 30% by mass with respect to the mass of the one or more polymeric compounds 204 and the mass of the metal particles 212 combined, from about 10% by mass to about 30% by mass with respect to the mass of the one or more polymeric compounds 204 and the mass of the metal particles 212 combined, or from about 20% by mass to about 30% by mass with respect to the mass of the one or more polymeric compounds 204 and the mass of the metal particles 212 combined.

In one or more examples, the metal particles 212 can comprise Ag⁰ particles. In one or more additional examples, the metal particles 212 can comprise Bi⁰ particles. In one or more further examples, the metal particles 212 can comprise Cu⁰ particles. In various examples, the metal particles 212 can comprise Sn⁰ particles. In still other examples, the metal particles 212 can comprise at least one of Ag⁰ particles, Bi⁰ particles, Cu⁰ particles, or Sn⁰ particles. In one or more illustrative examples, the metal particles 212 can have dimensions, such as at least one of length, width, or diameter, from about 0.008 millimeter (mm) to about 6 mm, from about 0.01 mm to about 5 mm, from about 1 mm to about 4 mm, from about 0.5 mm to about 2 mm, from about 1 mm to about 3 mm, from about 3 mm to about 6 mm, from about 5 micrometers (μm) to about 100 μm, from about 10 μm to about 80 μm,

In various examples, the third solution 218 can comprise water. In at least some examples, the third solution 218 can include deionized water. In one or more examples, the third solution 218 can have a temperature no greater than about 30° C., no greater than about 25° C., no greater than about 20° C., no greater than about 18° C., no greater than about 15° C., no greater than about 12° C., no greater than about 10° C., no greater than about 8° C., no greater than about 5° C., no greater than about 2° C., or no greater than about 1° C. In one or more additional examples, the third solution 218 can have temperatures from about 1° C. to about 30° C., from about 2° C. to about 25° C., from about 4° C. to about 20° C., from about 1° C. to about 5° C., from about 1° C. to about 8° C., from about 20° C. to about 30° C., from about 10° C. to about 20° C., or from about 5° C. to about 15° C.

In still other examples, the second container 216 can include or be otherwise associated with an additional mixing device 222. The additional mixing device 222 can include at least one of a mechanical mixing device or a sonic mixing device. In one or more illustrative examples, the additional mixing device 222 can include a mechanical stir bar, a paddle, or a sonicator. In various examples, the additional mixing device 222 can operation from about 1 minute to about 20 minutes, from about 2 minutes to about 15 minutes, from about 4 minutes to about 10 minutes, from about 1 minute to about 8 minutes, or from about 5 minutes to about 15 minutes to mix the third solution 218. In at least some examples, the sorbent fragments 220 can be subjected to at least one of one or more baths or one or more washes in water. In various examples, the sorbent fragments 220 can be subjected to additional processing with deionized water to remove additional amounts of the one or more solvents 202 from the sorbent fragments 220 through passive diffusion.

In various examples, the mixing of the second solution 214 can proceed until the second solution 214 is deposited in the third solution 218. In one or more examples, the second solution 214 can be deposited in the third solution 218 as droplets of the second solution 214. The droplets of the second solution 214 deposited in the third solution 218 can have diameters from about 0.5 mm to about 5 mm, from about 0.8 mm to about 4 mm, from about 1 mm to about 3 mm, from about 2 mm to about 3 mm, from about 3 mm to about 5 mm, or from about 0.5 mm to about 2 mm. In at least some examples, diameters of the droplets of the second solution 214 can depend on a temperature of the second solution 214. For example, as the temperature of the second solution 214 increases, the size of the droplets can decrease.

After being formed in the third solution 218 using the second solution 214, the sorbent fragments 220 can be removed from the second container 216 and can be subjected to one or more drying processes before being placed in a third container 224. The one or more drying processes can include placing the sorbent fragments 220 in a vacuum desiccator. In at least some examples, the sorbent fragments 220 can be placed in a vacuum desiccator or a vacuum oven for a period of time from about 0.5 days to about 60 days, from about 0.5 days to about 50 days, from about 1 day to about 10 days, from about 5 days to about 40 days, from about 10 days to about 30 days, from about 20 days to about 50 days, or from about 30 days to about 60 days. In various examples, the sorbent fragments 220 can be dried at temperatures from about 10° C. to about 40° or from about 20° C. to about 30° C. in air.

In one or more examples, the sorbent fragments 220 can have a bead-like shape. In various examples, the sorbent fragments 220 can have diameters from about 0.5 mm to about 5 mm, from about 0.8 mm to about 4 mm, from about 1 mm to about 3 mm, from about 2 mm to about 3 mm, from about 3 mm to about 5 mm, or from about 0.5 mm to about 2 mm. In one or more illustrative examples, the sorbent fragments 220 can have dimensions that correspond to dimensions of the droplets of the second solution 214 deposited in the third solution 218. In at least some examples, the metal particles 212 included in the sorbent fragments 220 can be suspended in a polymeric matrix comprised of the one or more polymeric compounds 204.

In at least some examples, the amounts of metal particles 212 and the amounts of the one or more polymeric compounds 204 present in the sorbent fragments 220 can correspond to the amounts of metal particles 212 and the amounts of the one or more polymeric compounds 204 present in the second solution 214. For example, the amount of metal particles 212 present in the sorbent fragments 220 can be from about 50% by mass to about 95% by mass with respect to the mass of the one or more polymeric compounds 204 and the mass of the metal particles 212 combined, from about 60% by mass to about 90% by mass with respect to the mass of the one or more polymeric compounds 204 and the mass of the metal particles 212 combined, from about 70% by mass to about 90% by mass with respect to the mass of the one or more polymeric compounds 204 and the mass of the metal particles 212 combined, or from about 70% by mass to about 80% by mass with respect to the mass of the one or more polymeric compounds 204 and the mass of the metal particles 212 combined. Additionally, the amount of the one or more polymeric compounds 204 present in the sorbent fragments 220 can be from about 5% by mass to about 50% by mass with respect to the mass of the one or more polymeric compounds 204 and the mass of the metal particles 212 combined, from about 10% by mass to about 30% by mass with respect to the mass of the one or more polymeric compounds 204 and the mass of the metal particles 212 combined, from about 10% by mass to about 30% by mass with respect to the mass of the one or more polymeric compounds 204 and the mass of the metal particles 212 combined, or from about 20% by mass to about 30% by mass with respect to the mass of the one or more polymeric compounds 204 and the mass of the metal particles 212 combined. Further, the sorbent fragments 220 can be free of iodine.

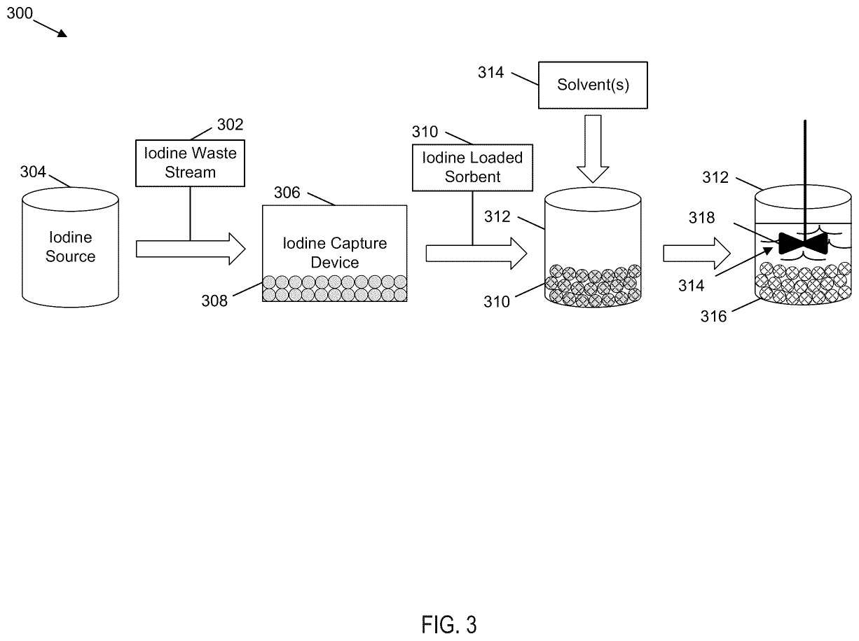

FIG. 3 illustrates a process 300 to capture iodine using polymer-metal composite materials and to remove a portion of the polymeric material from the polymer-metal composite, in accordance with one or more examples. The process 300 can include producing an iodine waste stream 302 from an iodine source 304. In one or more examples, the iodine waste stream 302 can include an aqueous stream that includes gaseous radioactive iodine. In one or more additional examples, the iodine waste stream 302 can include a gas waste stream that includes gaseous radioactive iodine. The iodine source 304 can include one or more nuclear fission processes. In various examples, the iodine source 304 can include one or more waste streams generated during the reprocessing of nuclear fuel. The iodine waste stream 302 can include radioiodine, such as radioisotopes ¹²⁹I and ¹³¹I.

The process 300 can also include providing the iodine waste stream 302 to an iodine capture device 306 that includes sorbent materials 308 to capture radioiodine present in the iodine waste stream 302. The iodine capture device 306 can be configured such that the iodine waste stream 302 contacts the sorbent materials 308 located in the iodine capture device 306. In various examples, the iodine capture device 306 include one or more beds in which the sorbent materials 308 are disposed. Additionally, the iodine capture device 306 can include one or more columns in which the sorbent materials 308 are disposed. In still other examples, the iodine capture device 306 can include at least one of one or more filters or one or more membranes in which the sorbent materials 308 are disposed. In one or more illustrative examples, the sorbent materials 308 can include implementations of the sorbent fragments 220 produced according to the process 200 described with respect to FIG. 2. In at least some examples, the sorbent materials 308 can comprise one or more zero-valent metals and one or more polymeric materials. For example, the sorbent materials 308 can include at least one of Ag⁰ particles, Bi⁰ particles, Cu⁰ particles, or Sn⁰ particles and polyacrylonitrile.

In addition, the process 300 can include producing iodine-loaded sorbent 310 in response to the sorbent materials 308 capturing radioactive iodine present in the iodine waste stream 302. The iodine-loaded sorbent 310 can be placed in a container 312. In one or more examples, the iodine-loaded sorbent 310 can be contacted with one or more solvents 314 to remove at least a portion of the one or more polymeric materials present in the iodine-loaded sorbent 310. The one or more solvents 314 can include at least one of DMSO, dimethyl acetamide, dimethyl formamide, ethyl carbonate, sulfolane, or N-methylpyrrolidone. In at least some examples, the one or more solvents 314 applied to the iodine-loaded sorbent 310 can correspond to the one or more solvents used to dissolve the one or more polymeric materials during the production of the sorbent materials 308. For example, in scenarios where DMSO is used to dissolve the one or more polymeric materials in the production of the sorbent materials 308, the one or more solvents 314 applied to the iodine-loaded sorbent 310 can include DMSO. In one or more illustrative examples, the amount of the one or more solvents 314 used to contact the iodine-loaded sorbent 310 can be sufficient to immerse the iodine-loaded sorbent 310 in the one or more solvents 314. In one or more additional examples, the iodine-loaded sorbent 310 can be contacted by a stream that includes the one or more solvents 314.

In various examples, a mixing device 318 can be coupled to or otherwise associated with the container 312. The mixing device 318 can include at least one of a mechanical mixing device or a sonic mixing device. In one or more examples, the mixing device 318 can include a mechanical stir bar, a paddle, or a sonicator. In one or more illustrative examples, the mixing device 318 can operate at speeds from about 50 RPM to about 1000 RPM, from about 100 RMP to about 900 RPM, from about 200 RPM to about 800 RPM, from about 300 RPM to about 700 RPM, or from about 400 RPM to about 600 RPM. In one or more additional illustrative examples, the mixing device 318 can operate from about 5 minutes to about 30 minutes to cause an amount of the one or more polymeric materials to leach from the iodine-loaded sorbent 310 to produce modified sorbent 316. The modified sorbent 316 can be a densified version of the iodine loaded sorbent 310. In at least some examples, the modified sorbent 316 can be removed from the container 312 and subjected to one or more heating processes to remove additional amounts of the one or more polymeric materials. For example, the modified sorbent 316 can be subjected to one or more heating operations above the decomposition temperature of the one or more polymeric materials present in the modified sorbent 316 to remove further amounts of the one or more polymeric materials. In still other examples, the modified sorbent 316 can be removed from the container 312 and subjected to one or more centrifugation processes, one or more rinsing processes, or one or more drying processes before undergoing one or more additional processes for final storage, such as one or more encapsulation processes.

In one or more examples, an amount of the one or more polymeric materials remaining in the modified sorbent 316 after one or more processes to remove the one or more polymeric materials from the iodine-loaded sorbent 310 can be no greater than about 80% of the initial amount of the one or more polymeric materials present in the iodine-loaded sorbent 310, no greater than about 70% of the initial amount of the one or more polymeric materials present in the iodine-loaded sorbent 310, no greater than about 60% of the initial amount of the one or more polymeric materials present in the iodine-loaded sorbent 310, no greater than about 50% of the initial amount of the one or more polymeric materials present in the iodine-loaded sorbent 310, no greater than about 40% of the initial amount of the one or more polymeric materials present in the iodine-loaded sorbent 310, no greater than about 30% of the initial amount of the one or more polymeric materials present in the iodine-loaded sorbent 310, no greater than about 20% of the initial amount of the one or more polymeric materials present in the iodine-loaded sorbent 310, or no greater than about 10% of the initial amount of the one or more polymeric materials present in the iodine-loaded sorbent 310.

By removing at least a portion of the one or more polymeric materials present in the iodine-loaded sorbent 310 to produce densified sorbent 316, the final density of a waste form produced using the modified sorbent 316 is greater than the density of a waste form produced using the iodine-loaded sorbent 310 without the removal of the one or more polymeric materials. The increased density of a final waste form produced using the densified sorbent 316 can increase the stability and durability of the final waste form. Additionally, removal of at least a portion of the one or more polymeric materials present in the iodine-loaded sorbent 310 to produce the modified sorbent 316 can result in flexibility in processes used to produce the final waste form because the impacts of the decomposition temperature of the one or more polymeric materials is decreased.

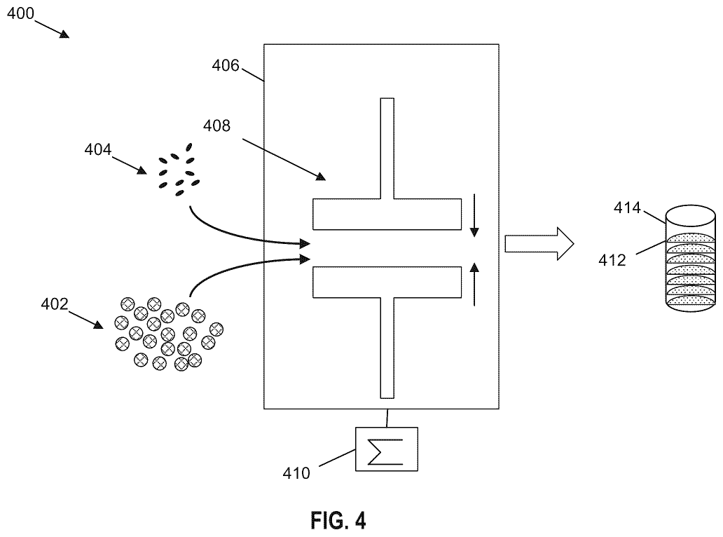

FIG. 4 illustrates a process 400 to encapsulate and store iodine that has been captured in a polymer-metal composite, in accordance with one or more examples. The process 400 can include providing iodine-loaded sorbent 402 and one or more encapsulation materials 404 to an apparatus 406. In one or more examples, the iodine-loaded sorbent 402 can include a metal-polymer composite in which radioactive iodine has been captured. In at least some examples, the iodine-loaded sorbent 402 can include at least one of Ag⁰ particles, Bi⁰ particles, Cu⁰ particles, or Sn⁰ particles and polyacrylonitrile. In one or more additional examples, the iodine-loaded sorbent 402 can include Ag-zeolites, such as silver mordenite and/or silver faujasite. In one or more further examples, the iodine-loaded sorbent 402 can include Ag-loaded alumina beads and/or Ag-loaded silica beads. In still other examples, the iodine-loaded sorbent 402 can include at least one of Ag-loaded aerogels, Ag-loaded xerogels, and Sn-based chalcogels. In one or more illustrative examples, the iodine-loaded sorbent 402 can include at least one of the iodine-loaded sorbents 108 described with respect to FIG. 1 or the iodine-loaded sorbent 310 described with respect to FIG. 3.

The one or more encapsulation materials 404 can include one or more metallic materials. In various examples, the one or more encapsulation materials 404 can include one or more metallic materials that have an affinity for iodine and that can function as a secondary barrier to capture any iodine released from iodine-loaded sorbent 402 to prevent release of the iodine into an environment. In one or more examples, the one or more encapsulation materials 404 can include Bi particles. In one or more additional examples, the one or more encapsulation materials 404 can include Sn particles. In one or more further examples, the one or more encapsulation materials 404 can include Bi—Sn alloy particles. In still other examples, the one or more encapsulation materials 404 can include Bi—Pb alloy particles. In one or more illustrative examples, the one or more encapsulation materials 404 can include at least one of Bi particles, Sn particles, Bi—Sn alloy particles, or Bi—Pb alloy particles.

In one or more examples where the one or more encapsulation materials 404 include a Bi—Sn alloy, the one or more encapsulation materials 404 can include a number of particles having from about 40% by mass Bi to about 70% by mass Bi, from about 50% by mass Bi to about 60% by mass Bi, or from about 55% by mass Bi to about 60% by mass Bi. Additionally, in situations where the one or more encapsulation materials 404 include a Bi—Sn alloy, the one or more encapsulation materials 404 can include a number of particles having from about 30% by mass Sn to about 60% by mass Sn, from about 40% by mass Sn to about 50% by mass Sn, or from about 40% by mass Sn to about 45% by mass Sn. In one or more illustrative examples, the one or more encapsulation materials 404 can include a number of metal particles comprised of a Bi—Sn eutectic compound that is comprised of about 58% by mass Bi and about 42% by mass Sn.

Additionally, where the one or more encapsulation materials 404 include a Bi—Pb alloy, the one or more encapsulation materials 404 can include a number of particles having from about 40% by mass Bi to about 70% by mass Bi, from about 50% by mass Bi to about 60% by mass Bi, or from about 55% by mass Bi to about 60% by mass Bi. Additionally, in situations where the one or more encapsulation materials 404 include a Bi—Pb alloy, the one or more encapsulation materials 404 can include a number of particles having from about 30% by mass Pb to about 60% by mass Pb, from about 40% by mass Pb to about 50% by mass Pb, or from about 40% by mass Pb to about 45% by mass Pb. In one or more illustrative examples, the one or more encapsulation materials 404 can include a number of metal particles comprised of a Bi—Pb eutectic compound that is comprised of about 55.5% by mass Bi and about 45.5% by mass Pb.

Further, an amount on a volume basis of the one or more encapsulation materials 404 provided to the apparatus 406 can be greater than an amount of the iodine-loaded sorbent 402 provided to the apparatus 406. For example, an amount of the one or more encapsulation materials 404 provided to the apparatus 406 can be up to 1.5 times greater than an amount of the one or more iodine-loaded sorbent fragments provided to the apparatus 406, up to 2.0 times greater than an amount of the one or more iodine-loaded sorbent fragments provided to the apparatus 406, up to 2.5 times greater than an amount of the one or more iodine-loaded sorbent fragments provided to the apparatus 406, up to 3.0 times greater than an amount of the one or more iodine-loaded sorbent fragments provided to the apparatus 406, up to 3.5 times greater than an amount of the one or more iodine-loaded sorbent fragments provided to the apparatus 406, up to 4.0 times greater than an amount of the one or more iodine-loaded sorbent fragments provided to the apparatus 406, up to 4.5 times greater than an amount of the one or more iodine-loaded sorbent fragments provided to the apparatus 406, up to 5.0 times greater than an amount of the one or more iodine-loaded sorbent fragments provided to the apparatus 406, up to 5.5 times greater than an amount of the one or more iodine-loaded sorbent fragments provided to the apparatus 406, up to 6.0 times greater than an amount of the one or more iodine-loaded sorbent fragments provided to the apparatus 406, up to 6.5 times greater than an amount of the one or more iodine-loaded sorbent fragments provided to the apparatus 406, up to 7.0 times greater than an amount of the one or more iodine-loaded sorbent fragments provided to the apparatus 406, up to 7.5 times greater than an amount of the one or more iodine-loaded sorbent fragments provided to the apparatus 406, up to 8.0 times greater than an amount of the one or more iodine-loaded sorbent fragments provided to the apparatus 406, up to 8.5 times greater than an amount of the one or more iodine-loaded sorbent fragments provided to the apparatus 406, up to 9.0 times greater than an amount of the one or more iodine-loaded sorbent fragments provided to the apparatus 406, up to 9.5 times greater than an amount of the one or more iodine-loaded sorbent fragments provided to the apparatus 406, or up to 10 times greater than an amount of the one or more iodine-loaded sorbent fragments provided to the apparatus 406.

In one or more examples, the apparatus 406 can include a pressure inducing device 408. The pressure inducing device 408 can operate to apply pressure to the iodine-loaded sorbent 402 and the one or more encapsulation materials 404 when the iodine-loaded sorbent 402 and the one or more encapsulation materials 404 are combined in the apparatus 406. In one or more examples, the pressure inducing device 408 can comprise or be included in a die that is part of the apparatus 406. The apparatus 406 can also include a heating device 410. The heating device 410 can operate to increase the temperature within the apparatus 406 in order to encapsulate the iodine-loaded sorbent 402 in the one or more encapsulation materials 404.

The process 400 can include producing encapsulated sorbent 412. The encapsulated sorbent 412 can include a ceramic-metal waste form. In these scenarios, the ceramic component of the encapsulated sorbent 412 can include one or metal iodides included in the iodine-loaded sorbent 402. For example, the ceramic component of the encapsulated sorbent 412 can correspond to at least one of AgI, CuI, SnI₂, SnI₄, BiI₃, or BiOI present in the encapsulated sorbent 402. In various examples, the metal iodides included in the iodine-loaded sorbent 402 can be produced by iodine present in an iodine waste stream contacting metals included in one or more sorbent materials. The metals included in the one or more sorbent materials can comprise at least one of Bi, Sn, Ag, or Cu, and can form the metal component of the ceramic-metal waste form that corresponds to the encapsulated sorbent 412. In one or more additional examples, the metal iodides present in the encapsulated sorbent 402 can be formed from one or more metal sulfides included in the one or more sorbent materials. In one or more scenarios, the one or more metal sulfides can include at least one of Ag₂S, Bi₂S₃, or Cu₂S. In one or more instances, metal sulfides present in the one or more sorbent materials can react with iodine present in an iodine waste stream to form one or more metal iodides and residual elemental sulfur. In at least some examples, the metal sulfides present in the one or more sorbent materials can be present as polymer-metal sulfide composites. To illustrate, the metal sulfides present in the one or more sorbent materials can be included in a polyacrylonitrile matrix.

In one or more examples, the encapsulated sorbent 412 can have a first phase comprised of one or more metal iodides and a second phase comprised of a metallic encapsulant material. In still other examples, the encapsulated sorbent 412 can comprise a first phase comprised of one or more first metallic encapsulant materials, a second phase comprised of one or more metal iodides, and a third phase comprised of one or more second metallic encapsulant materials with the second phase being disposed between the first phase and the third phase. In one or more implementations, the one or more second metallic encapsulant materials can be different from the one or more first encapsulant materials. Further, the one or more second metallic encapsulant materials can be the same as the one or more first encapsulant materials. In at least some examples, the phase comprised of the one or more metal iodides can also include an amount of one or more polymeric materials included in the encapsulated sorbent 402.

In various examples, the apparatus 406 can operate to apply at least one of pressure or heat to the iodine-loaded sorbent 402 and the one or more encapsulation materials 404 to produce the encapsulated sorbent 412. In one or more examples, the apparatus 406 can function to perform cold-press and sintering operations to produce the encapsulated sorbent 412. In one or more additional examples, the apparatus 406 can function to perform hot uniaxial pressing operations to produce the encapsulated sorbent 412. In at least some examples, the hot uniaxial pressing operations can include spark plasma sintering. In one or more further examples, the apparatus 406 can function to perform hot isostatic pressing operations to produce the encapsulated sorbent 412. In one or more illustrative examples, the encapsulated sorbent 412 can include encapsulated sorbent 112 described with respect to FIG. 1.

In various examples, the apparatus 406 can produce the encapsulated sorbent 412 from the iodine-loaded sorbent 402 and the one or more encapsulation materials 404 at temperatures that are less than the melting or decomposition temperature of metal iodides present in the encapsulated sorbent 412. In one or more illustrative examples, the iodine-loaded sorbent 402 can include at least one of AgI, CuI, BiOI, BiI₃, SnI₄, or SnI₂ and a melting or decomposition temperature of AgI can be about 558° C., a melting or decomposition temperature of CuI can be about 606° C., a melting or decomposition temperature of SnI₄ can be about 143° C., a melting or decomposition temperature of SnI₂ can be about 320° C., a melting or decomposition temperature of BiOI can be about 308° C., and a melting or decomposition temperature of BiI₃ can be about 408.6° C. In one or more additional illustrative examples, the apparatus 406 can produce the encapsulated sorbent 412 from the iodine-loaded sorbent 402 and the one or more encapsulation materials 404 at temperatures that are less than a decomposition temperature of one or more polymeric materials included in the iodine-loaded sorbent 402. To illustrative, polyacrylonitrile can be present in the iodine-loaded sorbent 402 and polyacrylonitrile can have a decomposition temperature or about 317° C. In one or more further illustrative examples, the melting points of materials that comprise the one or more encapsulation materials 404 can be less than the decomposition temperatures of materials included in the iodine-loaded sorbents 402. For example, the one or more encapsulation materials 404 comprised of about 100% by mass Bi can have a melting temperature of about 271° C., the one or more encapsulation materials 404 comprised of about 100% by mass Sn can have a melting temperatures of about 231.9° C., the one or more encapsulation materials 404 comprised of a Bi—Sn (58/42) eutectic compound can have a melting temperature of about 138° C., and the one or more encapsulation materials 404 comprised of a Bi—Pb (55.5/44.5) eutectic compound can have a melting temperature of about 124° C. Thus, in at least some examples, the apparatus 406 can produce the encapsulated sorbent 412 from the iodine-loaded sorbent 402 and the one or more encapsulation materials at temperatures that are lower than existing processes for encapsulated iodine-loaded sorbents. In this way, the processes performed by the apparatus 406 can minimize the release of iodine from the iodine-loaded sorbent 402 in the production of the encapsulated sorbent 412.

In one or more examples, the apparatus 406 can produce an encapsulated sorbent 412 from the iodine-loaded sorbent 402 and the one or more encapsulation materials 404 by implementing the heating device 410 to expose the iodine-loaded sorbent 402 and the one or more encapsulation materials 404 to temperatures of no greater than about 600° C., no greater than about 550° C., no greater than about 500° C., no greater than about 450° C., no greater than about 400° C., no greater than about 380° C., no greater than about 360° C., no greater than about 340° C., no greater than about 320° C., no greater than about 300° C., no greater than about 290° C., no greater than about 280° C., no greater than about 270° C., no greater than about 260° C., no greater than about 250° C., no greater than about 240° C., no greater than about 230° C., no greater than about 220° C., no greater than about 210° C., no greater than about 200° C., no greater than about 190° C., no greater than about 180° C., no greater than about 170° C., no greater than about 160° C., no greater than about 150° C., no greater than about 140° C., no greater than about 130° C., no greater than about 120° C., no greater than about 110° C., or no greater than about 100° C. In one or more additional examples, the apparatus 406 can produce an encapsulated sorbent 412 from the iodine-loaded sorbent 402 and the one or more encapsulation materials 404 at temperatures from 100° C. to 600° C., from 200° C. to 500° C., from 300° C. to 400° C., from 100° C. to 200° C., from 200° C. to 300° C., from 400° C. to 500° C., from 90° C. to 140° C., from 120° C. to 180° C., from 150° C. to 200° C., from 190° C. to 240° C., from 220° C. to 280° C., from 250° C. to 300° C., from 280° C. to 330° C., from 300° C. to 350° C., from 320° C. to 380° C., from 390° C. to 430° C., from 400° C. to 450° C., or from 450° C. to 500° C.

In one or more further examples, the apparatus 406 can produce an encapsulated sorbent 412 from the iodine-loaded sorbent 402 and the one or more encapsulation materials 404 by compressing at least one of the iodine-loaded sorbents 402 and the one or more encapsulation materials 404 using the pressure inducing device 408. In still other examples, the apparatus 406 can produce an encapsulated sorbent 412 from the iodine-loaded sorbent 402 and the one or more encapsulation materials 404 at about atmospheric pressure, such as at pressures from 0.095 megapascals (MPa) to about 0.115 MPa. In scenarios where the pressure inducing device 408 is used to compress the iodine-loaded sorbent 402 and the one or more encapsulation materials 404, the encapsulated sorbent 412 can be produced at pressures from about 1 MPa to about 700 MPa, from about 20 MPa to about 600 MPa, from about 50 MPa to about 500 MPa, from about 100 MPa to about 400 MPa, from about 1 MPa to about 100 MPa, from about 100 MPa to about 200 MPa, from about 200 MPa to about 400 MPa, from about 300 MPa to about 500 MPa, from about 400 MPa to about 600 MPa, or from 500 MPa to about 700 MPa. In one or more examples, pressure can be applied to the iodine-loaded sorbent 402 and the one or more encapsulation materials 404 by the pressure inducing device 408 for a period of time comprising from 0.3 minutes to 30 minutes, from 0.5 minutes to 25 minutes, from 1 minute to 20 minutes, from 5 minutes to 15 minutes, from 1 minutes to 20 minutes, from 5 minutes to 15 minutes, from 10 minutes to 20 minutes, from 15 minutes to 30 minutes, or from 20 minutes to 30 minutes.

In still other examples, the apparatus 406 can produce the encapsulated sorbent 412 from the iodine-loaded sorbent 402 and the one or more encapsulation materials 404 in a container that includes air present in an environment in which the apparatus 406 is located. Additionally, the apparatus 406 can produce the encapsulated sorbent 412 from the iodine-loaded sorbent 402 and the one or more encapsulation materials 404 in a container that includes argon gas (Ar₂(g)).

In at least some examples, the encapsulated sorbent 412 can be in the form of pellets. In these scenarios, the encapsulated sorbent 412 can comprise pellets having diameters from about 2 mm to about 400 mm, from about 5 mm to about 200 mm, from about 10 mm to about 100 mm, from 5 mm to about 40 mm, from about 8 mm to about 20 mm, from about 5 mm to about 15 mm, from about 10 mm to about 20 mm, from about 15 mm to about 25 mm, from about 20 mm to about 30 mm, from about 25 mm to about 35 mm, from about 30 mm to about 40 mm, from about 5 mm to about 10 mm, from about 10 mm to about 15 mm, from about 15 mm to about 20 mm, from about 20 mm to about 25 mm, from about 25 mm to about 30 mm, from about 30 mm to about 35 mm, or from about 35 mm to about 40 mm. Additionally, the encapsulated sorbent 412 can comprise pellets having heights from about 0.5 mm to about 100 mm, from about 1 mm to about 50 mm, from about 2 mm to about 25 mm, from about 1 mm to about 10 mm, from about 1 mm to about 5 mm, from about 2 mm to about 6 mm, from about 3 mm to about 7 mm, from about 4 mm to about 8 mm, from about 5 mm to about 9 mm, from about 6 mm to about 10 mm, from about 7 mm to about 11 or from about 8 mm to about 12 mm. In various examples, the apparatus 406 can include a die that is used to form pellets from the iodine-loaded sorbent 402 and the one or more encapsulation materials 404.

The encapsulated sorbent 412 can include an amount of metal iodides included in the iodine-loaded sorbent 402 and an amount of the one or more encapsulation materials 404. In various examples, the encapsulated sorbent 412 can include an amount of a polymeric material included in the iodine-loaded sorbent 402. In one or more illustrative examples, the amount of metal iodides present in the encapsulated sorbent 412 can correspond to an amount of the iodine-loaded sorbent 402 used to form the encapsulated sorbent 412 and the amount of the one or more encapsulation materials 404 present in the encapsulated sorbent 412 can correspond to an amount of the one or more encapsulation materials 404 used to form the encapsulated sorbent 412. To illustrate, the encapsulated sorbent 412 can include from about 60% by mass to about 90% by mass of one or more encapsulation materials 404 and from about 10% by mass to about 40% by mass of materials included in the iodine-loaded sorbent 402, such as at least one of one or more metal iodides or one or more polymeric materials. Additionally, the encapsulated sorbent 412 can include from about 70% by mass to about 80% by mass of one or more encapsulation materials 404 and from about 20% by mass to about 30% by mass of materials included in the iodine-loaded sorbent 402, such as at least one of one or more metal iodides or one or more polymeric materials. Further, the encapsulated sorbent 412 can include from about 80% by mass to about 90% by mass of one or more encapsulation materials 404 and from about 10% by mass to about 20% by mass of materials included in the iodine-loaded sorbent 402, such as at least one of one or more metal iodides or one or more polymeric materials. In still other examples, the encapsulated sorbent 412 can include from about 75% by mass to about 85% by mass of one or more encapsulation materials 404 and from about 15% by mass to about 25% by mass of materials included in the iodine-loaded sorbent 402, such as at least one of one or more metal iodides or one or more polymeric materials.

Additionally, the encapsulated sorbent 412 can be stored in a container 414. In one or more examples, the container 414 can be comprised of one or more metallic materials that can capture any iodine released from the encapsulated sorbent 412. In various examples, the container 414 can be comprised of materials that will withstand decay over long periods of time.

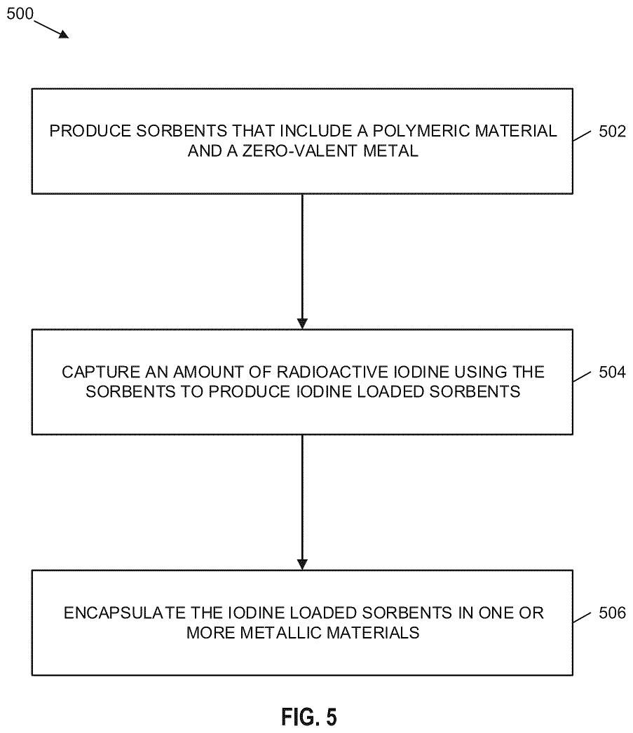

FIG. 5 illustrates a flow diagram of a process 500 to capture and store iodine produced in conjunction with a nuclear fission process, in accordance with one or more examples. The process 500 can include, at 502, producing sorbent material that includes a polymeric material and a zero-valent metal. In at least some examples, the one or more polymeric materials can include a polyacrylonitrile. In addition, the one or more zero valent metals can comprise at least one of Ag⁰ particles, Bi⁰ particles, Cu⁰ particles, or Sn⁰ particles. In one or more examples, the sorbent material can be free of iodine.

In one or more examples, the sorbent material can be produced by combining an amount of one or more solvents with an amount of the one or more polymeric materials to produce a first solution. Additionally, the sorbent material can be produced by providing one or more metal particles including the zero-valent metal to the first solution to produce a second solution. In one or more additional examples, an amount of the second solution can be from a container and the amount of the second solution can be combined with a third solution located in an additional container to form at least a portion of the sorbent material. The third solution can comprise water at a temperature from about 1° C. to about 30° C. In one or more illustrative examples, the sorbent materials can have a bead-like shape having maximum diameters from about 0.5 mm to about 4 mm.

The one or more solvents can include at least one of dimethyl sulfoxide (DMSO), dimethyl acetamide, dimethyl formamide, ethyl carbonate, sulfolane, or N-methylpyrrolidone. In one or more examples, a ratio of volume of the one or more solvents to mass of the polymeric materials can be from about 12 mL of the one or more solvents/1 g of the one or more polymeric materials. In various examples, the amount of the one or more solvents and the amount of the one or more polymeric materials can be combined in a container with the one or more polymeric materials using a mixing device that operates at speed from about 100 rotations per minute (RPM) to about 700 RPM. In at least some examples, the amount of the one or more zero-valent metals present in the second solution can be from about 70% by mass to about 90% by mass with respect to the mass of the one or more polymeric compounds and the mass of the one or more metal particles combined. Further, the amount of the one or more polymeric compounds present in the second solution can be from about 10% by mass to about 30% by mass with respect to the mass of the one or more polymeric compounds and the mass of the metal particles combined.

In addition, at 504, the process 500 can include capturing an amount of radioactive iodine using the sorbent material to produce iodine-loaded sorbents. In one or more examples, the radioactive iodine can be captured by contacting the sorbent material with a stream comprising radioactive iodine to produce the iodine-loaded sorbent. In at least some examples, the iodine-loaded sorbent can include one or more metal iodides and the one or more polymeric materials. The one or more metal iodides can be comprised of iodine from the stream and the one or more zero-valent metals. The radioactive iodine can include gaseous iodine present in one or more waste streams produced by nuclear fission reactions. Additionally, the radioactive iodine includes at least one of ¹²⁹I or ¹³¹I.

In various examples, after producing the iodine-loaded sorbent, the iodine-loaded sorbent can be provided to a container and then contacted with one or more additional solvents in at least one additional container to produce densified sorbent. The densified sorbent can have an amount of the one or more polymeric materials that is less than an initial amount of the one or more polymeric materials present in the iodine-loaded sorbent. In one or more examples, the one or more additional solvents can include at least one of DMSO, dimethyl acetamide, dimethyl formamide, ethyl carbonate, sulfolane, or N-methylpyrrolidone. In one or more illustrative examples, the one or more additional solvents can include DMSO and the sorbent material can be produced using DMSO. In at least some examples, an amount of the one or more polymeric materials remaining in the densified sorbent after contacting the iodine-loaded sorbent with the one or more additional solvents can be no greater than about 50% of the initial amount of the one or more polymeric materials present in the iodine-loaded sorbent.

Further, at 506, the process 500 can include encapsulating the iodine-loaded sorbent in one or more metallic materials. In one or more examples, the one or more metallic materials used to encapsulate the iodine-loaded sorbents can include at least one of Bi particles, Sn particles, Bi—Sn alloy particles, or Bi—Pb alloy particles. In one or more illustrative examples, the Bi—Sn alloy particles can comprise from about 50% by mass Bi to about 60% by mass Bi and from about from about 40% by mass Sn to about 50% by mass Sn. For example, the Bi—Sn alloy particles can be comprised of a eutectic mixture of Bi and Sn. In one or more additional illustrative examples, the Bi—Pb alloy particles can comprise from about 50% by mass Bi to about 60% by mass Bi and from about from about 40% by mass Pb to about 50% by mass Pb. To illustrate the Bi—Pb alloy particles can be comprised of a eutectic mixture of Bi and Pb. In one or more further illustrative examples, the encapsulated sorbent can comprise from about 70% by mass to about 90% by mass of the one or more metallic materials and from about 10% by mass to about 30% by mass of one or more materials included in the iodine-loaded sorbent.

In various examples, encapsulating the iodine-loaded sorbent in the one or more metallic materials can include providing the iodine-loaded sorbent and the one or more metallic materials to an apparatus that applies at least one of heat or pressure to the iodine-loaded sorbents and the one or more metallic materials to produce encapsulated sorbent. In one or more examples, the apparatus can include a die. In one or more examples, the apparatus can include a die that produces the encapsulated sorbent in the form of pellets having diameters from about 5 mm to about 10 mm and having heights from about 1 mm to about 3 mm. In at least some examples, heat can be applied to the iodine-loaded sorbents and the one or more metallic materials within the apparatus at temperatures from about 100° C. to about 300° C. In one or more additional examples, the apparatus can include a pressure-inducing device that can apply pressure to the iodine-loaded sorbent and the one or more metallic materials within the apparatus at pressures from about 5 MPa to about 500 MPa.

In one or more illustrative examples, the iodine-loaded sorbent can be encapsulated in the one or more metallic materials using a cold press operation followed by a sintering operation. In one or more additional illustrative examples, the iodine-loaded sorbent can be encapsulated in the one or more metallic materials using hot uniaxial pressing operations. In one or more further illustrative examples, the iodine-loaded sorbent can be encapsulated in the one or more metallic materials using spark plasma sintering. In still other illustrative examples, the iodine-loaded sorbent can be encapsulated in the one or more metallic materials using hot isostatic pressing operations.

In at least some examples, the iodine-loaded sorbent can be encapsulated between one or more first layers of the one or more metallic materials and one or more second layers of the one or more metallic materials. In one or more examples, a first layer of the one or more metallic materials can be placed in an apparatus and pressed at pressures from about 5 MPa to about 50 MPa. Iodine-loaded sorbent can then be added to the pressed first metallic layer and undergo a second pressing process in the apparatus at pressures from about 10 MPa to about 75 MPa to produce an intermediate pressed object including the pressed iodine-loaded sorbent layer disposed on the first layer of the one or more metallic materials. In at least some examples, one or more metallic materials can be added to the iodine-loaded sorbent before the second pressing process is performed. Additionally, a third pressing process can be performed by adding an amount of the one or more metallic materials to the intermediate pressed object to produce one or more second layers of the one or more metallic materials on the pressed iodine-loaded sorbent of the intermediate pressed object. The third pressing process can be performed at pressures from about 5 MPa to about 50 MPa to produce the encapsulated sorbent. In various examples, one or more additional layers of the one or more metallic materials can be used to produce the one or more first layers of the one or more metallic materials and the one or more second layers of the one or more metallic materials.

A numbered non-limiting list of examples of the present subject matter is presented below.

Example 1 is a method comprising: producing sorbent material that include, one or more polymeric materials and one or more zero-valent metals; capturing an amount of radioactive iodine using the sorbent material to produce iodine-loaded sorbent; and encapsulating the iodine-loaded sorbent in one or more metallic materials.

In Example 2, the subject matter of Example 1 includes, combining an amount of one or more solvents with an amount of the one or more polymeric materials to produce a first solution; and providing one or more metal particles including the one or more zero-valent metals to the first solution to produce a second solution.

In Example 3, the subject matter of Example 2 includes, wherein the one or more solvents include at least one of dimethyl sulfoxide (DMSO), dimethyl acetamide, dimethyl formamide, ethyl carbonate, sulfolane, or N-methylpyrrolidone.

In Example 4, the subject matter of Examples 2-3 wherein a ratio of volume of the one or more solvents to mass of the one or more polymeric materials is from about 12 mL to about 18 mL of the one or more solvents/1 g of the one or more polymeric materials.

In Example 5, the subject matter of Examples 2-4 includes, wherein the amount of the one or more solvents and the amount of the one or more polymeric materials are combined in a container with the one or more polymeric materials using a mixing device that operates at speed from about 300 rotations per minute (RPM) to about 700 RPM.

In Example 6, the subject matter of Examples 2-5 includes, wherein the amount of the one or more zero-valent metals present in the second solution is from about 70% by mass to about 90% by mass with respect to the mass of the one or more polymeric materials and the mass of the one or more metal particles combined.

In Example 7, the subject matter of Examples 2-6 includes, wherein the amount of the one or more polymeric materials present in the second solution is from about 10% by mass to about 30% by mass with respect to the mass of the one or more polymeric materials and the mass of the one or more metal particles combined.

In Example 8, the subject matter of Examples 1-7 includes, wherein the one or more polymeric materials include polyacrylonitrile.

In Example 9, the subject matter of Examples 1-8 includes, wherein the one or more zero-valent metals comprise at least one of Ag⁰ particles, Bi⁰ particles, Cu⁰ particles, or Sn⁰ particles.

In Example 10, the subject matter of Examples 2-9 includes, removing an amount of the second solution from a container; and providing the amount of the second solution to a third solution located in an additional container to form at least a portion of the sorbent material.

In Example 11, the subject matter of Example 10 includes, wherein the third solution comprises water at a temperature from about 1° C. to about 30° C.

In Example 12, the subject matter of Examples 1-11 includes, wherein the sorbent material has a bead-like shape having diameters from about 0.5 mm to about 4.0 mm.

In Example 13, the subject matter of Examples 1-12 includes, contacting the sorbent material with a stream comprising radioactive iodine to produce the iodine-loaded sorbent, the iodine-loaded sorbent including one or more metal iodides and the one or more polymeric materials, wherein the one or more metal iodides are comprised of iodine from the stream and the one or more zero-valent metals.

In Example 14, the subject matter of Example 13 includes, wherein the radioactive iodine is gaseous iodine present in one or more waste streams produced by nuclear fission reactions.

In Example 15, the subject matter of Examples 13-14 includes, wherein the radioactive iodine includes at least one of ¹²⁹I or ¹³¹I.

In Example 16, the subject matter of Examples 13-15 includes, providing the iodine-loaded sorbent to a container; and contacting the iodine-loaded sorbent with one or more additional solvents in the container to produce modified iodine-loaded sorbent, wherein the modified iodine-loaded sorbent has an amount of the one or more polymeric materials that is less than an initial amount of the one or more polymeric materials present in the iodine-loaded sorbent.

In Example 17, the subject matter of Example 16 includes, wherein the one or more additional solvents include at least one of DMSO, dimethyl acetamide, dimethyl formamide, ethyl carbonate, sulfolane, or N-methylpyrrolidone.

In Example 18, the subject matter of Examples 16-17 includes, wherein the one or more additional solvents include DMSO and the sorbent material was produced using DMSO.

In Example 19, the subject matter of Examples 16-18 includes, wherein an amount of the one or more polymeric materials remaining in the modified iodine-loaded sorbent is no greater than about 50% of the initial amount of the one or more polymeric materials present in the iodine-loaded sorbent.

In Example 20, the subject matter of Examples 1-19 includes, wherein the one or more metallic materials used to encapsulate the iodine-loaded sorbent include at least one of Bi particles, Sn particles, Bi—Sn alloy particles, or Bi—Pb alloy particles.

In Example 21, the subject matter of Example 20 includes, wherein the Bi—Sn alloy particles comprise from about 50% by mass Bi to about 60% by mass Bi and from about from about 40% by mass Sn to about 50% by mass Sn.

In Example 22, the subject matter of Examples 20-21 includes, wherein the Bi—Sn alloy particles are comprised of a eutectic mixture of Bi and Sn.

In Example 23, the subject matter of Examples 20-22 includes, wherein the Bi—Pb alloy particles comprise from about 50% by mass Bi to about 60% by mass Bi and from about from about 40% by mass Pb to about 50% by mass Pb.

In Example 24, the subject matter of Examples 20-23 includes, wherein the Bi—Pb alloy particles are comprised of a eutectic mixture of Bi and Pb.

In Example 25, the subject matter of Examples 1-24 includes, providing the iodine-loaded sorbent and the one or more metallic materials to an apparatus that applies at least one of heat or pressure to the iodine-loaded sorbent and the one or more metallic materials to produce encapsulated sorbent.

In Example 26, the subject matter of Example 25 includes, wherein the apparatus is a die and the apparatus produces the encapsulated sorbent in the form of pellets having diameters from about 5 mm to about 10 mm having heights from about 1 mm to about 3 mm.

In Example 27, the subject matter of Examples 25-26 includes, applying heat to the iodine-loaded sorbent and the one or more metallic materials within the apparatus at temperatures from about 100° C. to about 300° C.

In Example 28, the subject matter of Examples 25-27 includes, applying a pressure-inducing device to the iodine-loaded sorbent and the one or more metallic materials within the apparatus at pressures from about 5 megapascals (MPa) to about 700 MPa.

In Example 29, the subject matter of Examples 25-28 includes, wherein the encapsulated sorbent comprises from about 70% by mass to about 90% by mass of the one or more metallic materials and from about 10% by mass to about 30% by mass of one or more materials included in the iodine-loaded sorbent.

In Example 30, the subject matter of Examples 1-29 includes, wherein the iodine-loaded sorbent is encapsulated in the one or more metallic materials using a cold press operation following by a sintering operation.

In Example 31, the subject matter of Examples 1-30 includes, wherein the iodine-loaded sorbent is encapsulated in the one or more metallic materials using hot uniaxial pressing operations.

In Example 32, the subject matter of Examples 1-31 includes, wherein the iodine-loaded sorbent is encapsulated in the one or more metallic materials using spark plasma sintering.

In Example 33, the subject matter of Examples 1-32 includes, wherein the iodine-loaded sorbent is encapsulated in the one or more metallic materials using hot isostatic pressing operations.

Example 34 is an article comprising: a first component comprising one or more polymeric materials; and a second component disposed within the first component, the second component comprising one or more zero-valent metals and the one or more zero-valent metals including at least one of Ag⁰ particles, Bi⁰ particles, Cu⁰ particles, or Sn⁰ particles.

In Example 35, the subject matter of Example 34 includes, wherein the one or more polymeric materials include polyacrylonitrile.

In Example 36, the subject matter of Examples 34-35 includes, wherein an amount of the one or more zero-valent metals present in the article is from about 70% by mass to about 90% by mass with respect to the mass of the one or more polymeric materials and the mass of the one or more zero valent metals in the article combined.

In Example 37, the subject matter of Examples 34-36 includes, wherein an amount of the one or more polymeric materials present in the article is from about 10% by mass to about 30% by mass with respect to the mass of the one or more polymeric materials and the mass of the one or more zero-valent metals in the article combined.

In Example 38, the subject matter of Examples 34-37 includes, wherein the article has a body having a bead-like shape and the body has a diameter from about 0.5 mm to about 4 mm.

In Example 39, the subject matter of Examples 34-38 includes, wherein the article is formed using a method of any one of claims 1-12.

Example 40 is an article comprising: a first component including one or more metal iodide compounds; and a second component encapsulating the first component, the second component including one or more metallic materials.

In Example 41, the subject matter of Example 40 includes, wherein the one or more metal iodide compounds include a radioactive isotope of iodine.

In Example 42, the subject matter of Examples 40-41 includes, wherein the one or more metal iodide compounds include at least one of AgI, CuI, BiOI, BiI₃, SnI₄, or SnI₂.

In Example 43, the subject matter of Examples 40-42 includes, wherein the one or more metallic materials include at least one of Bi particles, Sn particles, Bi—Sn alloy particles, or Bi—Pb alloy particles.

In Example 44, the subject matter of Example 43 includes, wherein the Bi—Sn alloy particles comprise from about 50% by mass Bi to about 60% by mass Bi and from about from about 40% by mass Sn to about 50% by mass Sn.

In Example 45, the subject matter of Examples 43-44 includes, wherein the Bi—Sn alloy particles are comprised of a eutectic mixture of Bi and Sn.

In Example 46, the subject matter of Examples 43-45 includes, wherein the Bi—Pb alloy particles comprise from about 50% by mass Bi to about 60% by mass Bi and from about from about 40% by mass Pb to about 50% by mass Pb.

In Example 47, the subject matter of Examples 43-46 includes, wherein the Bi—Pb alloy particles are comprised of a eutectic mixture of Bi and Pb.

In Example 48, the subject matter of Examples 40-47 includes, wherein the article comprises from about 70% by mass to about 90% by mass of the one or more metallic materials and from about 10% by mass to about 30% by mass of the one or more metal iodide compounds.

In Example 49, the subject matter of Examples 40-48 includes, wherein the article is formed using a method of any one of claims 20-33.

Example 50 is a method, comprising: combining an amount of one or more solvents with an amount of one or more polymeric materials to produce a first solution; providing one or more metal particles including one or more zero-valent metals to the first solution to produce a second solution; and forming sorbent material using the second solution, the sorbent material including the one or more polymeric materials and the one or more zero-valent metals.

In Example 51, the subject matter of Example 50 includes, wherein the one or more solvents include at least one of dimethyl sulfoxide (DMSO), dimethyl acetamide, dimethyl formamide, ethyl carbonate, sulfolane, or N-methylpyrrolidone.

In Example 52, the subject matter of Examples 50-51 includes, wherein a ratio of volume of the one or more solvents to mass of the one or more polymeric materials is from about 12 mL to about 18 mL of the one or more solvents/1 g of the one or more polymeric materials.

In Example 53, the subject matter of Examples 50-52 includes, wherein the amount of the one or more solvents and the amount of the one or more polymeric materials are combined in a container with the one or more polymeric materials using a mixing device that operates at speed from about 300 rotations per minute (RPM) to about 700 RPM.

In Example 54, the subject matter of Examples 50-53 includes, wherein the amount of the one or more zero-valent metals present in the second solution is from about 70% by mass to about 90% by mass with respect to the mass of the one or more polymeric materials and the mass of the one or more metal particles combined.

In Example 55, the subject matter of Examples 50-54 includes, wherein the amount of the one or more polymeric materials present in the second solution is from about 10% by mass to about 30% by mass with respect to the mass of the one or more polymeric materials and the mass of the one or more metal particles combined.

In Example 56, the subject matter of Examples 50-55 includes, wherein the one or more polymeric materials include a polyacrylonitrile.

In Example 57, the subject matter of Examples 50-56 includes, wherein the one or more zero-valent metals comprise at least one of Ag⁰ particles, Bi⁰ particles, Cu⁰ particles, or Sn⁰ particles.

In Example 58, the subject matter of Examples 50-57 includes, removing an amount of the second solution from a container; and providing the amount of the second solution to a third solution located in an additional container to form at least a portion of the sorbent material.

In Example 59, the subject matter of Example 58 includes, wherein the third solution comprises water at a temperature from about 1° C. to about 30° C.

In Example 60, the subject matter of Examples 50-59 includes, wherein the sorbent material has a bead-like shape having diameters from about 0.5 mm to about 4.0 mm.

In Example 61, the subject matter of Examples 1-60 includes, contacting sorbent material comprising one or more polymeric materials and one or more zero-valent metals with a stream comprising radioactive iodine to produce iodine-loaded sorbent, the iodine-loaded sorbent including one or more metal iodides and the one or more polymeric materials, wherein the one or more metal iodides are comprised of iodine from the stream and the one or more zero-valent metals; providing the iodine-loaded sorbent to a container; and contacting the iodine-loaded sorbent with one or more solvents in the container to produce a modified iodine-loaded sorbent, wherein the modified iodine-loaded sorbent has an amount of the one or more polymeric materials that is less than an initial amount of the one or more polymeric materials present in the iodine-loaded sorbent.

In Example 62, the subject matter of Example 61 includes, wherein the radioactive iodine is gaseous iodine present in one or more waste streams produced by nuclear fission reactions.

In Example 63, the subject matter of Examples 61-62 includes, wherein the radioactive iodine includes at least one of ¹²⁹I or ¹³¹I.

In Example 64, the subject matter of Examples 61-63 includes, wherein the one or more solvents include at least one of DMSO, dimethyl acetamide, dimethyl formamide, ethyl carbonate, sulfolane, or N-methylpyrrolidone.

In Example 65, the subject matter of Example 64 includes, wherein the one or more solvents include DMSO and the sorbent material was produced using DMSO.

In Example 66, the subject matter of Examples 61-65 includes, wherein an amount of the one or more polymeric materials remaining in the densified sorbent after contacting the iodine-loaded sorbent with the one or more solvents is no greater than about 50% of the initial amount of the one or more polymeric materials present in the iodine-loaded sorbent.

Example 67 is a method comprising: contacting sorbent material comprising one or more polymeric materials and one or more zero-valent metals with a stream comprising radioactive iodine to produce iodine-loaded sorbent, the iodine-loaded sorbent including one or more metal iodides and the one or more polymeric materials, wherein the one or more metal iodides are comprised of iodine from the stream and the one or more zero-valent metals; and providing the iodine-loaded sorbent and one or more metallic materials to an apparatus that applies at least one of heat or pressure to the iodine-loaded sorbent and the one or more metallic materials to produce encapsulated sorbent.

In Example 68, the subject matter of Example 67 includes, wherein the one or more metallic materials used to encapsulate the iodine-loaded sorbent include at least one of Bi particles, Sn particles, Bi—Sn alloy particles, or Bi—Pb alloy particles.

In Example 69, the subject matter of Example 68 includes, wherein the Bi—Sn alloy particles comprise from about 50% by mass Bi to about 60% by mass Bi and from about from about 40% by mass Sn to about 50% by mass Sn.

In Example 70, the subject matter of Example 69 includes, wherein the Bi—Sn alloy particles are comprised of a eutectic mixture of Bi and Sn.

In Example 71, the subject matter of Examples 67-70 includes, wherein the Bi—Pb alloy particles comprise from about 50% by mass Bi to about 60% by mass Bi and from about from about 40% by mass Pb to about 50% by mass Pb.

In Example 72, the subject matter of Examples 67-71 includes, wherein the Bi—Pb alloy particles are comprised of a eutectic mixture of Bi and Pb.

In Example 73, the subject matter of Examples 67-72 includes, wherein the apparatus is a die and the apparatus produces the encapsulated sorbent in the form of pellets having diameters from about 5 mm to about 10 mm having heights from about 1 mm to about 3 mm.

In Example 74, the subject matter of Examples 67-73 includes, applying heat to the iodine-loaded sorbent and the one or more metallic materials within the apparatus at temperatures from about 100° C. to about 300° C.

In Example 75, the subject matter of Examples 67-74 includes, applying a pressure-inducing device to the iodine-loaded sorbent and the one or more metallic materials within the apparatus at pressures from about 5 megapascals (MPa) to about 700 MPa.

In Example 76, the subject matter of Examples 67-75 includes, wherein the encapsulated sorbent comprises from about 70% by mass to about 90% by mass of the one or more metallic materials and from about 10% by mass to about 30% by mass of one or more materials included in the iodine-loaded sorbent.

In Example 77, the subject matter of Examples 67-76 includes, wherein the iodine-loaded sorbent is encapsulated in the one or more metallic materials using a cold press operation following by a sintering operation.

In Example 78, the subject matter of Examples 67-77 includes, wherein the iodine-loaded sorbent is encapsulated in the one or more metallic materials using hot uniaxial pressing operations.

In Example 79, the subject matter of Examples 67-78 includes, wherein the iodine-loaded sorbent is encapsulated in the one or more metallic materials using spark plasma sintering.

In Example 80, the subject matter of Examples 67-79 includes, wherein the iodine-loaded sorbent is encapsulated in the one or more metallic materials using hot isostatic pressing operations.

### EXPERIMENTAL EXAMPLES

### Example 1

Radioiodine is generated during fission of nuclear fuels and includes several radioisotopes including long-lived ¹²⁹I (t_{1/2}=1.57×10⁷ years) and short-lived ¹³¹I (t_{1/2}=8.02 days) that can be released during nuclear accidents or during reprocessing of used nuclear fuel. The release of radioiodine is a high-visibility environmental issue due to the detrimental effects on human health where it can lead to thyroid cancer. Different solid sorbents including zeolites, aerogels, xerogels, chalcogels, porous organic polymers, and metal-organic frameworks have been studied for the capture of gaseous iodine that utilize chemisorption, physisorption, or both as the method of capture. For metal-exchanged zeolite sorbents, the iodine loading capacities (qₑ) generally range from 100 to 450 mg/g (mass of iodine per mass of starting sorbent). For Ag-loaded aerogels, Ag-loaded xerogels, and Sn-based chalcogel sorbents, the qₑ values are generally higher than metal-exchanged zeolites due to higher getter utilization and tend to range from 400 to >2000 mg/g. This could be partially due to higher specific surfaces areas (m² g⁻¹) in the gel-based sorbents compared to the zeolites. In addition to these sorbents for gaseous radioiodine, other metal-based sorbents with porous scaffolds have been investigated such as Ag- or Bi-functionalized Ni-metal foams. The metal foam approach might provide a method for combining the active metal sites with an active porous metal support, depending on the metal used for the foam support. For radioiodine chemisorption, a few different getter metals have been identified as having both high iodine affinity and low metal-iodide leach rates that include Ag, Bi, Cu, and Pb, which could help solve both the iodine capture need and the long-term stability need for disposal of radioiodine in a geological repository.

In this study, the iodine loading capacities of as-received Ag⁰, Bi⁰, Cu⁰, and Sn⁰ metal particles were compared with hybrid sorbents containing these same metals embedded in polyacrylonitrile (PAN)-based composite beads. These sorbents show high iodine loading capacities (qₑ=474-3000 mg per gram of initial sorbent) and their appearances, micro/macrostructures, and chemistries were investigated with optical microscopy, pycnometry, X-ray diffraction (XRD), scanning electron microscopy (SEM), and energy dispersive X-ray spectroscopy (EDS). X-ray absorption hear-edge structure (XANES) analyses, including Bi L₃ and I L₃ edges, were also conducted on the Bi-containing materials. This work was based off our previous study evaluating pure metal wires without the porous polymer scaffold and the 75 mass % loadings used were based on previous work on embedding active particle or powdered sorbents into PAN composites. Due to kinetics limitations of iodine vapors reacting through thick (0.5 mm) wires from a separate study, small particles were selected for use in the current study as the active metal sites.

### Synthesis of Metal Containing PAN Composites

Fine metal particles of Ag⁰ (635 mesh, 99.9%), Bi⁰ (325 mesh, 99.5%), Cu⁰ (10 μm, 99.9%), and Sn⁰ (325 mesh, 99.8%) acquired from Alfa Aesar were used as received. Information on the precursors and sample synthesis details are provided in Table 1. For the synthesis of each PAN composite, ˜0.2 g of PAN fibers (×100, 3.3 dtex, 60 mm; Dralon GmbH, Dormagen, Germany) were separately dissolved in 3 mL of dimethyl sulfoxide (DMSO; ≥99.9%, Sigma Aldrich) within a 20-mL Pyrex beaker covered with Parafilm. After the PAN fibers were completely dissolved (˜15 min), ˜0.6 g of metal particles were slowly added to the DMSO-PAN mixture (75 mass % active metal in the total solids), and the mixture was stirred over a time of ˜5 min until it was homogenously suspended in the mixture. To prevent particle settling, the mixture was stirred continuously just up to the point of the next step. This mixture of metal, PAN, and DMSO was slowly poured in batches into 5 mL pipette tip positioned at −5 cm above a stirring 150-mL deionized water (DIW, >18.2 MΩ-cm) bath at 1-7° C., where the cooler temperatures were achieved by placing this DIW dish inside a separate ice water bath. The droplets were gravity assisted into the DIW water dish and formed into metal-PAN composite beads with “oblate spheroidal external surfaces” as described in our previous study using this same process with different active getters. After stirring in the DIW water bath for 10 min, the beads were transferred to a separate dish with fresh DIW two separate times for a total of ˜400 mL of DIW exposure over the course of 30 minutes to aid in DMSO removal of bead interiors through passive diffusion. After these DIW exchanges, the beads were removed from the third dish, blotted dry with a paper towel, transferred to separate glass scintillation vials for each different bead type, and dried in a vacuum desiccator at room temperature over the course of a 2-3 weeks. The same synthesis method was used for all four metal-PAN composites, and each metal-PAN composite contained 75 mass % of metal (on a solids basis). For naming the samples, Ag⁰-, Bi⁰-, Cu⁰-, and Sn⁰-based metal-PAN composite beads were denoted as Ag-PAN, Bi-PAN, Cu-PAN, and Sn-PAN, respectively.

TABLE 1
Details from batching metal-PAN composites including
the total mass of PAN, volume of DMSO used,
and mass of metal particles added.

| | PAN | DMSO | Metal |
|---|---|---|---|
| Sample | (g) | (mL) | (g) |
| Ag-PAN | 0.2014 | 3.0 | 0.6015 |
| Bi-PAN | 0.2008 | 3.0 | 0.6012 |
| Cu-PAN | 0.2002 | 3.0 | 0.6010 |
| Sn-PAN | 0.2002 | 3.0 | 0.5994 |

Gaseous Iodine Loading into Metal-PAN Composites and Particles

Iodine loadings for both the metal-PAN composites and metal particles were performed at 120±1° C. to estimate the loading capacity of gaseous iodine using a high-precision oven (Thermo Scientific Lindberg Blue M). For these experiments, 0.01-0.04 g of each sorbent sample (mₛ) was placed into separate tared 4 mL glass vials (Qorpak GLC-00980). The masses of metal particles (mm) added equated to ˜75 mass % of the total solids masses in the composite beads so the total getter masses for all samples was similar (assuming no reaction from the PAN in the metal-PAN composites). All the open vials containing metal-PAN composites and metal particles were placed into 1 L perfluoroalkoxy (PFA) jar (Savillex, Eden Prairie, MN). A glass vial containing solid iodine pieces (99.99%, Sigma Aldrich) and a 4 mL blank vial were also placed into the PFA jar. Additionally, Ag-faujasite (IONEX Ag-400) was added as a standard to each iodine-loading run.

The mass of solid iodine was equal to 1.5× the stoichiometric amount needed for full conversion of Ag⁰, Bi⁰, Cu⁰, Sn⁰ into AgI, BiI₃, CuI, and SnI₄, respectively; the blank vial was added to check iodine adsorption on the vial (for background corrections). The PFA jar was tightly sealed and placed into the oven at 120±1° C. for 48 h, and then the vials were removed from the container and placed in a separate oven (Fisher Scientific Isotemp 3511FSQ) at ˜100±8° C. for 1 h to remove weakly physisorbed iodine. For naming the samples, iodine-loaded Ag-PAN, Bi-PAN, Cu-PAN, and Sn-PAN metal-PAN composite beads were given a “+I” suffix (e.g., Ag-PAN+I). For particle samples without PAN, similar notations were used (e.g., Ag-Particle+I). For Bi-PAN and Bi⁰ particles, additional experiments were done at 24 h and 72 h with a similar experimental setup and the time was added as a suffix to the sample names [e.g., Bi-PAN+I (24 h)]. A total of four separate iodine loading runs were run including (1) the 48-h run with Ag-Particle, Ag-PAN, Bi-Particle, Bi-PAN, Cu-Particle, and Cu-PAN; (2) the 48-h run with Sn-Particle and Sn-PAN; (3) the 24-hr run with Bi-Particle and Bi-PAN, and (4) the 72-hr run with Bi-particle and Bi-PAN.

Using Equations (1-1), (1-2), and (1-3), the gravimetric iodine capacities of the pure metal particles and the metal-PAN composites were calculated where mₛ was the starting mass of the sample, m_{s+I} is the final mass following iodine capture, m_{I} was the mass of iodine captured by the sample based on mass changes, m %_{I} was the mass % of iodine in the final sample, and iodine loading (Qₑ) is denoted as m_{I}/mₛ, which is the mass of iodine captured per starting mass of the sorbent (in g/g). Often times another term is used in the literature called qₑ, which utilizes the milligrams of iodine per gram of sorbent mass (mg/g) or 1000·m_{I}/mₛ, which is shown in Equation (1-4).

$${m}_{I} = {m}_{s + I} - {m}_{s} \qquad ( 1 - 1 )$$

$$m {\%}_{I} = 100 - ( {m}_{I} / {m}_{s + I} ) \qquad ( 1 - 2 )$$

$${Q}_{e} = {m}_{I} / {m}_{s} ( g / g ) \qquad ( 1 - 3 )$$

$$qe = 1000 \cdot {m}_{I} / {m}_{s} ( mg / g ) \qquad ( 1 - 4 )$$

Based on the data derived from these equations, additional calculations were made, as described below. The first calculation was the maximum iodine mass possible (m_{I,max}) based on initial sorbent mass (mₛ) shown in Equation (1-5), which is based solely on metal-iodine chemisorption to fully react metals into the expected metal-iodide complexes (MIₓ; i.e., AgI, BiI₃, CuI, and SnI₄ for Ag⁰, Bi⁰, Cu⁰, and Sn⁰, respectively, assuming no reaction with the PAN matrix) where mf_{ML} is the mass fraction of metal loading in the sorbent (i.e., 1.00 for metal particles and 0.75 for metal-PAN composites), xi is the molecular weight of iodine, xₘ is the molecular weight of the base metal in the sorbent, and M_{I} is the moles of iodine in the reacted metal-iodide compound (MIₓ; e.g., M_{I}=3 for BiI₃). Additionally, the maximum possible Qₑ values (Q_{e,max}) can be determined using Equation (1-6) utilizing the initial sample mass (mₛ) and the m_{I,max} value calculated from Equation (1-5). Alternatively, these values were also calculated in terms of mg/g loadings using the q_{e,max} notation shown in Equation (1-7).

$${m}_{I , max} = \frac{{m}_{s} \cdot {mf}_{M L} \cdot {x}_{I} \cdot {M}_{I}}{{x}_{m}} \qquad ( 1 - 5 )$$

$${Q}_{e , max} ( g / g ) = {m}_{I , max} / {m}_{s} \qquad ( 1 - 6 )$$

$${q}_{e , max} ( mg / g ) = 1000 \cdot {Q}_{e , max} \qquad ( 1 - 7 )$$

The total mass of metal-iodide in the reacted sorbent (m_{m-I}) was calculated with Equation (1-8) based on the total mass gain and all gained mass was assumed as metal converted to a metal iodide (MIₓ), where x_{m-I} is the molecular weight of the metal-iodide compound, and the other variables were previously defined. Based on the data from the above calculations, the residual (unreacted) metal present in the sorbent (m_{m,r}) can be calculated with Equation (1-9) where the variables were previously defined. Then, the conversion % (C % m) based on mass data alone can be calculated using Equation (1-10) with the m_{I} and m_{I,max} values or m_{m,r} and mm and values. These calculations assume all mass uptake was iodine capture and that no water (or other chemical, e.g., residual DMSO) adsorption/desorption occurred from the metal-PAN composites or the metal particles during the iodine-loading experiments.

$${m}_{m - I} = \frac{{m}_{I} {x}_{m - I}}{{x}_{I} \cdot {M}_{I}} \qquad ( 1 - 8 )$$

$${m}_{m , r} = {m}_{s + I} - {m}_{P A N} - {m}_{m - I} \qquad ( 1 - 9 )$$

$$C \% m = 100 \cdot ( {m}_{I} / {m}_{I , max} ) = 100 \cdot ( ( {m}_{m} - {m}_{m , r} ) / {m}_{m} ) \qquad ( 1 - 10 )$$

Finally, the mass fraction values of the iodine-loaded sorbent constituents can then be calculated to further compare some of the datasets using Equation (1-11) for PAN (mf_{PAN}), Equation (1-12) for the residual metal (mf_{m,r}), and Equation (1-13) for the MIₓ loading (mf_{m-I}). The values of mf_{NP,m,r} and mf_{NP,m-I} calculated using Equation (1-14) and Equation (1-15) are mass fractions from renormalizing after removing the m_{PAN} (“NP” subscript denotes “no PAN”) from the calculations in Equation (1-12) and Equation (1-13), respectively, so they are just comparing changes in m_{m,r} and m_{m-I}.

$$m {f}_{P A N} = {m}_{P A N} / ( {m}_{s + I} ) \qquad ( 1 - 11 )$$

$$m {f}_{m , r} = {m}_{m , r} / ( {m}_{s + I} ) \qquad ( 1 - 12 )$$

$$m {f}_{m - I} = {m}_{m - I} / ( {m}_{s + I} ) \qquad ( 1 - 13 )$$

$$m {f}_{NP , m , r} = {m}_{m , r} / ( {m}_{s + I} - {m}_{P A N} ) \qquad ( 1 - 14 )$$

$$m {f}_{NP , m - I} = {m}_{m - I} / ( {m}_{s + I} - {m}_{P A N} ) \qquad ( 1 - 15 )$$

### Iodine Capture in the Aqueous Medium

Iodide (I⁻) removal was evaluated for the Ag-PAN, Bi-PAN, and Cu-PAN composites. Here, each of the composites were added to separate 15 mL centrifuge vials, and then 10 mL of a caustic scrubber simulant was added. The samples were mixed with a rotary mixer (Model AD3740-12RA10 Phipps & Bird, Inc.) for 24 h with 1 mL aliquots collected at 0 h, 1 h, 4 h, and 24 h. The amounts of media added corresponds to an equimolar of Ag/Bi/Cu fraction and I⁻ concentration. The aliquots were stabilized with 0.5 vol % of UniSolv Neutralizing and Stabilizing Reagent (UNS-2B, Inorganic Ventures) and submitted for inductively coupled plasma mass spectroscopy (ICP-MS) for ¹²⁷I and ion chromatography (IC) for the other anions. For ICP-MS, iodine was measured quantitatively for mass 127 using a Thermo Scientific X-Series quadrupole instrument with an Elemental Scientific SC4 DX FAST auto-sampler interface. For IC, samples were quantitatively measured using a Dionex Reagent Free IC System (RFICS) 2000 with an AS-1 auto-sampler interface or a Dionex RFICS 5000 with an AS-AP auto-sampler interface.

### Characterizations

### Photography and Optical Microscopy

Photographs were captured of the samples using a Rebel T7 digital camera (Canon U.S.A., Inc., Huntington, NY) on a tripod using the Canon EOS Utility software (v3.15.20). Optical micrographs were taken of the samples using a ProgRes SpeedXTcore 5 (Jenoptik, Jena, Germany) connected to a Leica MZ125 stereo microscope. Pictures were taken of a ruler at the same magnifications for each image so that scalebars could be added later in Adobe Photoshop (v23.5.1).

### Density (Pycnometry)

Densities of metal-PAN beads were calculated using measured volumes by a helium pycnometer (Micromeritics AccuPyc II 1340). The accuracy of volume measurement was checked with the standard sphere from Micromeritics before the volume measurement. The sample cup of 1 cm³ was filled with metal-PAN beads and inserted into the pycnometer and 10 volume measurements were performed for each sample. Using AccuPyc II software, the densities were calculated with the average volumes and inputted sample masses.

### X-Ray Diffraction

For XRD analyses, crushed metal-PAN composites and metal particles were placed on zero-background quartz holders (MTI corporation, Richmond, CA) and scanned with a Bruker D8 Advance Xray diffractometer (Bruker AXS Inc., Madison, WI) with a Cu source and a LynxEye position-sensitive detector or scintillator detector, and the scan parameters were 10-70° 20 with a step of 0.020 and 1-4 s dwell times per step. For the phase identification and quantification, Bruker AXS DIFFRACplus EVA (v4.1) and TOPAS (v5) software programs were used, respectively, using crystallographic information files from the Inorganic Crystal Structure Database for refinements (v4.8.0, build 20220419-1910; FIZ Karlsruhe GmbH).

### Scanning Electron Microscopy and Energy Dispersive X-Ray Spectroscopy

The SEM-EDS analyses were performed with a JSM-7001F field-emission gun microscope (JEOL USA, Inc.; Peabody, MA) on metal particles and metal-PAN composites cut into halves and adhered to aluminum stubs with carbon tape. The EDS analyses were performed with a Bruker xFlash 6160 detector (Bruker AXS Inc., Madison, WI). Samples were not coated and were analyzed in low-vacuum mode (30 Pa) to prevent charging artifacts.

### 2.4.5 Particle Size Distribution

Particle size distributions (PSDs) were measured on the as-received metal particles using a Mastersizer 2000 (Malvern Instruments, Inc., Southborough, MA) with a HydroS wet dispersion accessory with a measurement range of 0.02-600 μm. Measurements were made before, during, and after sonication, allowing determination of the influence of sonication on the distribution of particle sizes within the sample.

### Metal-PAN Composite Measurements

The metal-PAN composites were measured with the measurement tool in Adobe Photoshop (v23.5.1) by taking pictures of several beads using a MZ125 microscope (Leica Microsystems, Deerfield, IL) along with pictures at the same magnification with a NIST Micro-Ruler (Geller MicroÅnalytical Laboratory, Inc., Topsfield, MA). Measurements were made on the smallest and largest dimensions of sitting beads, which excluded the third dimension, that was likely the smallest of the three diameters. Values were averaged and standard deviations (±1σ) were calculated.

### X-Ray Absorption Near-Edge Structure

XANES analyses were performed near the Bi L3-edge (13.419 keV) and the I L3-edge (4.557 keV) at the 12-BM-B beamline of the Advanced Photon Source (APS) at Argonne National Laboratory using a Si(111) monochromator. The data were collected in transmission and fluorescence modes simultaneously, however only data captured in fluorescence mode were utilized for this study. For preparing samples, approximately 5-10 mg of sample powders were used with no binder while 2-3 mg standards were separately mixed with ˜2-3 mg of carbowax polyethylene glycol (PEG) molecular weight 8000 binder (Fisher, >95%) and pressed into 7-mm diameter pellets at 70 MPa using a uniaxial press then cut to fit the sample holders.

Linear combination fittings of Bi L3-edge XANES spectra were performed to estimate the Bi speciation in the samples as well as the redox ratio of Bi³⁺/Bi⁰. This approach assumed that each sample was a linear combination of measured spectra (si) from Bi⁰ (Bi metal, Thermo Scientific 99.5%) and Bi³⁺ species [i.e., Bi2O3 (Alfa Aesar, 99.975%), BiOI (Alfa Aesar, >98%), and/or BiI₃ (Alfa Aesar, 99.999%) after iodine sorption] with these four species summing to 1, shown in Equation (1-16), where rᵢ is the mole fraction of species “i” (denoted in brackets) within the sample. The concentrations for the four species were fit to data using a least-squares approach.

$${\sum }_{i = 1}^{n} {r}_{i} {s}_{i} = {r}_{1} [ {Bi}^{0} ] + {r}_{2} [ {Bi}_{2} {O}_{3} ] + {r}_{3} [ BiOI ] + {r}_{4} [ {BiI}_{3} ] = 1 \qquad ( 1 - 16 )$$

The I L3-edge XANES analyses were performed utilizing beamline 12-BM-B at APS operated in fluorescence mode using a Si(111) monochromator and calibrated using AgI powder (Alfa Aesar, Premion, 99.999%). The step size for I L3-edge measurements were 5.0 eV (for the energy range of 4.410-4.547 keV), 0.4 eV (for 4.547-4.577 keV), and 0.05 Å-1 (for 4.577-4.800 keV). These data were not used for phase quantifications, but rather qualitative comparisons.

### Results

### Characterization of Base Sorbents

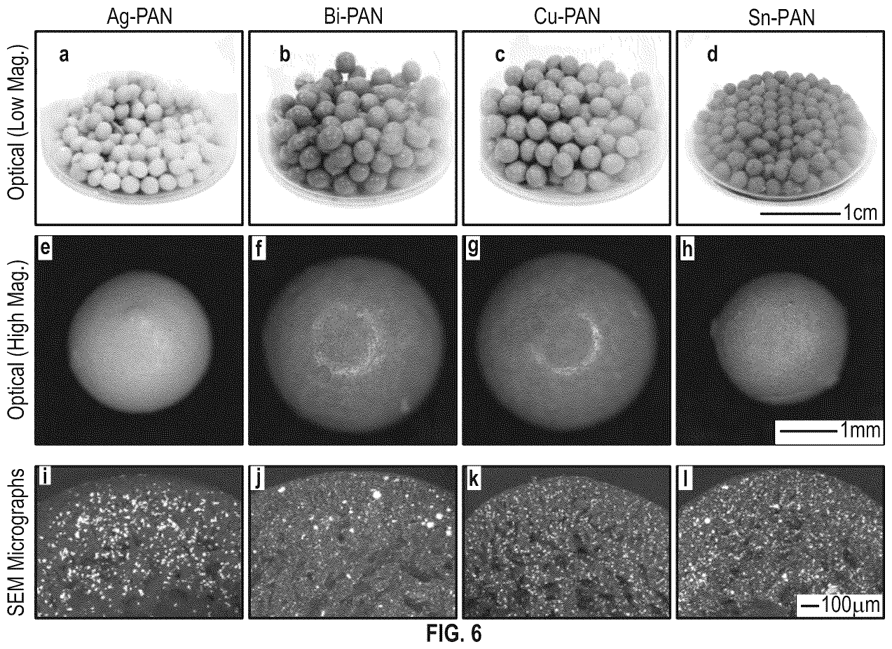

The PSD datasets for the as-received metal particles show the average sizes [or d(0.5) values] of the Ag⁰, Bi⁰, Cu⁰, and Sn⁰ particles were 18.992, 4.893, 10.276, and 9.810 μm, respectively. The appearances of metal-PAN composite beads before iodine loading are shown in FIG. 6. The shapes of beads were ellipsoidal with some irregularities, and the sizes were in the range of 2.29-3.09 mm at the largest diameters. Pure PAN beads without any added metals were white, but for Ag-PAN, Bi-PAN, Cu-PAN, and Sn-PAN, the composite beads were beige, dark grey, taupe, and light grey, respectively, with some color variabilities from bead to bead that are attributed to fluctuations in metal loadings (FIG. 6). These colors matched well with the colors of initial metal particles. All the as-made metal-PAN composite beads were malleable and deformed under pressure with similar degrees of spring-back. The metal particles in all four separate metal-PAN composites were found to be homogeneously distributed within the different sets of beads. The Ag⁰ and Sn⁰ particles were relatively larger than Bi⁰ and Cu⁰ particles within the PAN matrix and could be due to some agglomeration. The densities of the metal-PAN composites show somewhat of a linear trend of increasing overall ρ_{pc} with increasing metal densities (ρₘ) with the exception of Ag-PAN. The Sn-PAN and Ag-PAN densities were the lowest in the series despite the fact that the ρₘ for Ag is the highest and this could be attributed to closed porosity in the Ag-PAN composites not accessible to the He gas.

### Iodine Loading Data (48 hr)

### Appearances

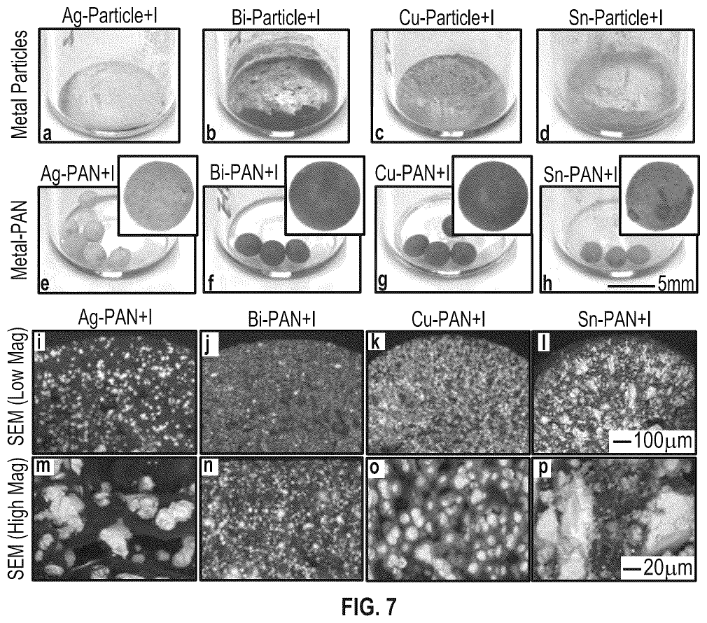

Pictures of the iodine-loaded metal particles and metal-PAN composites are shown in FIG. 7, items a-h. The appearances of both metal particles and the metal-PAN composites for each sample set were similar in color where Ag-, Bi-, Cu-, and Sn-based samples were yellow, gray, brown, and orange/brown, respectively, with some slight color shifts between the iodine loaded metal-PAN composites and the metal particles for Ag and Sn. FIG. 7, items i-p provide SEM micrographs of the metal-PAN composites shown at two different magnifications. The appearances of the metal-iodide complexes varied extensively in size, shape, and morphology between the different samples, and this is attributed to initial metal particle size distributions and shapes as well as the large masses of chemisorbed iodine, which led to swelling of the local composite structure. After iodine loading, the metal-PAN composite surfaces were harder and much less malleable than in the as-made metal-PAN composites. The sizes of the metal-PAN composites did not appear to notably change after iodine loading, which might be expected based on the large addition of iodine mass to the composites during loading.

### 3.2.2 Iodine Mass Data

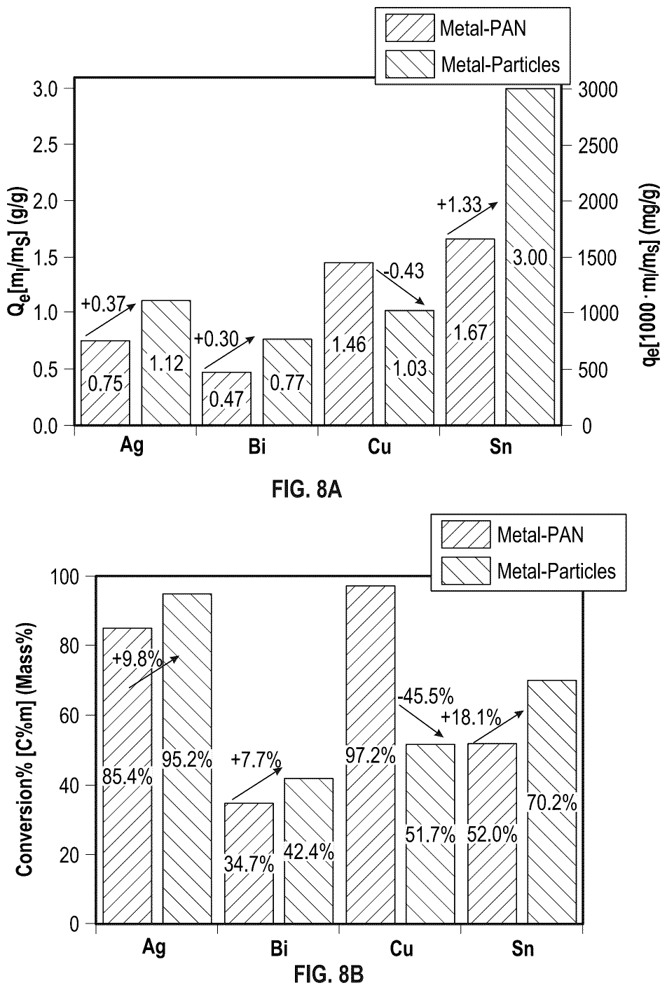

The iodine loading capacities of the metal-PAN composite beads and metal particles for 48 h were calculated using the gravimetric methods described in Equations (1-1), (1-2), and (3) (see Table 2) and these data are shown graphically in FIG. 8A. The results of iodine loading experiments for 48 h at 120±1C showed Sn-PAN+I with the highest Qₑ (m_{I}/mₛ) value of 1.669 followed by Cu-PAN+0 with 1.457, Ag-PAN+9 with 0.753, and Bi-PAN+2 with 0.474 (FIG. 8A and Table 2). Pure metal particles showed higher loading capacities over the metal-PAN composites except for Cu, and further investigation is required to understand the chemisorption of iodine into PAN composites to explain this particular anomaly (FIGS. 8A and B and Table 2).

TABLE 2
Iodine loading measured with a gravimetric method listing experimental time (t, hr) samples were exposed
to 120 ± 1° C., sample mass (mₛ), iodine-loaded sample masses (m_{s+I}), iodine mass (m_{I}),
m_{I}/mₛ, iodine mass uptake (m %_{I}), maximum iodine mass possible (m_{I, max}) based on full
metal-iodine chemisorption) to form MIₓ, the maximum possible iodine mass uptake based on target
metal-iodide stoichiometries (Q_{e, max}), and the actual conversion % based on mass data (C % m).
Iodine exposure times were 48 h unless otherwise labeled in sample IDs.

| | t | mₛ | m_{s+I} | m_{I} | m %_{I} | m_{I}/mₛ | m_{I, max} | Q_{e, max} | C % m |
|---|---|---|---|---|---|---|---|---|---|
| Sample ID | (hr) | (g) | (g) | (g) | (mass %) | (g⁻¹) | (g) | (g/g) | (mass %) |
| Ag-PAN + I | 48 | 0.0369 | 0.0647 | 0.0278 | 42.97 | 0.753 | 0.0326 | 0.882 | 85.4% |
| Bi-PAN + I | 48 | 0.0293 | 0.0432 | 0.0139 | 32.18 | 0.474 | 0.0400 | 1.366 | 34.7% |
| Cu-PAN + I | 48 | 0.0276 | 0.0678 | 0.0402 | 59.29 | 1.457 | 0.0413 | 1.498 | 97.2% |
| Sn-PAN + I | 48 | 0.0359 | 0.0958 | 0.0599 | 62.53 | 1.669 | 0.1151 | 3.207 | 52.0% |
| Ag-Particle + I | 48 | 0.0292 | 0.0619 | 0.0327 | 52.83 | 1.120 | 0.0344 | 1.176 | 95.2% |
| Bi-Particle + I | 48 | 0.0216 | 0.0383 | 0.0167 | 43.60 | 0.773 | 0.0394 | 1.822 | 42.4% |
| Cu-Particle + I | 48 | 0.0214 | 0.0435 | 0.0221 | 50.80 | 1.033 | 0.0427 | 1.997 | 51.7% |
| Sn-Particle + I | 48 | 0.0275 | 0.1100 | 0.0825 | 75.00 | 3.000 | 0.1176 | 4.276 | 70.2% |
| Bi- | 24 | 0.0196 | 0.0268 | 0.0072 | 26.87 | 0.367 | 0.0268 | 1.366 | 26.9% |
| PAN + I(24 h) | | | | | | | | | |
| Bi- | 72 | 0.0331 | 0.0666 | 0.0335 | 50.30 | 1.012 | 0.0452 | 1.366 | 74.1% |
| PAN + I(72 h) | | | | | | | | | |
| Bi- | 24 | 0.0147 | 0.0230 | 0.0083 | 36.09 | 0.565 | 0.0268 | 1.822 | 31.0% |
| Particle + I(24 h) | | | | | | | | | |
| Bi- | 72 | 0.0246 | 0.0586 | 0.0340 | 58.02 | 1.382 | 0.0448 | 1.822 | 75.9% |
| Particle + I(72 h) | | | | | | | | | |

Based on the precursor masses of metal particles in the metal-PAN composites, the theoretical maximum possible iodine mass uptake was calculated based on formation of the stoichiometric compounds (i.e., Ag→AgI, Bi→BiI₃, Cu→CuI, and Sn→SnI₄) and these were compared to the actual masses of metal particles and metal-PAN composites to achieve the conversion efficiencies on a mass basis [denoted as C % m in Equation (1-10)] shown in FIG. 8B and Table 2. For the 48-h exposures, both Ag-PAN and Cu-PAN showed high C % m values of 85.4% and 97.2%, respectively, whereas Bi⁰ and Sn⁰ had C % m values of 34.7% and 52.0%, respectively (FIG. 8B and Table 2). Nevertheless, the Qe value of the Sn-PAN composite was higher than Ag-PAN, Bi-PAN, and Cu-PAN due to the formation of SnI₄ (FIG. 8A). As for Bi-PAN, the Qₑ value was lower than the other metal-PAN composites even with formation of BiI₃ as XRD showed the presence of unreacted Bi⁰ phases after iodine loading.

### 3.2.3 XRD Data

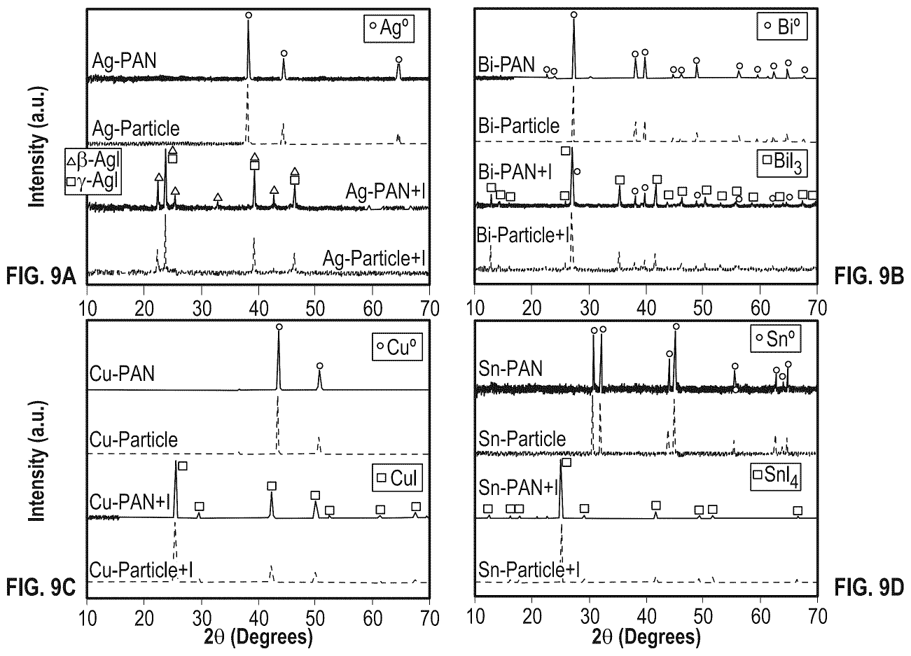

The XRD results showed only metal phases of Ag⁰, Bi⁰, Cu⁰, and Sn⁰ in the as-made metal-PAN composites and metal particles (see Table 3 and FIGS. 9A-D). After iodine loading, the metal-iodide phases detected included AgI, BiI₃, CuI, and SnI₄, respectively (see Table 3 and FIGS. 9A-D). Based on the XRD refinements, the crystallite sizes of metals in the PAN beads were consistently smaller than crystallite sizes found for the as-received metal particles (Table 3). For Ag-PAN, only the Ag⁰ phase was initially present as expected, and during iodine loading at 120±1° C. for 48 h, β-AgI (34 mass %) and γ-AgI (66 mass %) phases were formed through chemisorption of I₂(g) (FIG. 9A). For Bi-PAN+I, partial conversion of Bi⁰ to BiI₃ was observed after 48 h of iodine loading at 120±1° C. (FIG. 9B). For Cu-PAN+I, only CuI was present after iodine loading for 48 h (FIG. 9C). For Sn-PAN+I, Sn⁰ particles and I₂(g) reacted to form SnI₄, and no other crystalline phases were observed after 48 h (FIG. 9D). The formation of the SnI₄ compound was beneficial for the efficiency of iodine capture as one Sn atom captures four iodine atoms. Iodine loading experiments were also performed on pure metal particles that were used for PAN composite synthesis to compare the structural changes during iodine uptake. The results of iodine loading on pure metal particles showed the same resulting phases as with the metal-PAN composites.

TABLE 3
XRD data including phases, phase concentrations (mass %), and
crystallite size (nm) for the metal-PAN composites and metal
particles after iodine loading based on Rietveld refinements.

| | | Concentration | Crystallite size |
|---|---|---|---|
| Sample | Phases | (mass %) | (nm) |
| Ag-PAN | Ag⁰ | 100 | 79 |
| Bi-PAN | Bi⁰ | 100 | 232 |
| Cu-PAN | Cu⁰ | 100 | 87 |
| Sn-PAN | Sn⁰ | 100 | 101 |
| Ag-Particle | Ag⁰ | 100 | 116 |
| Bi-Particle | Bi⁰ | 100 | 277 |
| Cu-Particle | Cu⁰ | 100 | 109 |
| Sn-Particle | Sn⁰ | 100 | 186 |
| Ag-PAN + I | β-AgI, γ-AgI | 34.15, 65.85 | 57, 66 |
| Bi-PAN + I | Bi⁰, BiI₃ | 15.47, 84.53 | 165, 68 |
| Cu-PAN + I | CuI | 100 | 77 |
| Sn-PAN + I | SnI₄ | 100 | 255 |
| Ag-Particle + I | β-AgI, γ-AgI | 21.63, 78.37 | 108, 98 |
| Bi-Particle + I | Bi⁰, BiI₃ | 14.65, 85.35 | 232, 68 |
| Cu-Particle + I | CuI | 100 | 97 |
| Sn-Particle + I | SnI₄ | 100 | 159 |
| Bi-PAN + I-24 h | Bi⁰, BiI₃ | 27.51, 72.49 | 156, 49 |
| Bi-PAN + I-72 h | BiI₃ | 100 | 77 |
| Bi-Particle + I-24 h | Bi⁰, BiI₃ | 23.47, 76.53 | 221, 62 |
| Bi-Particle + I-72 h | BiI₃ | 100 | 106 |

3.3 Time-Based Study with Bi-Based Sorbents (24, 48, and 72 h)

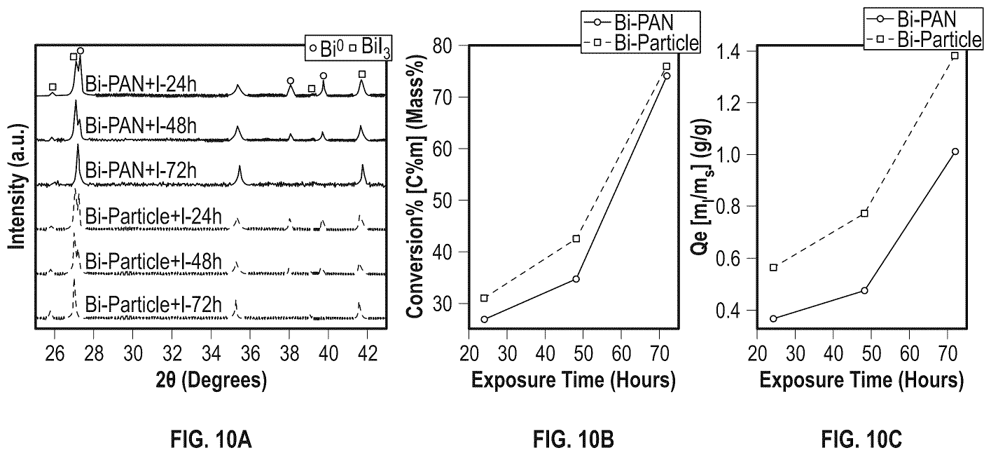

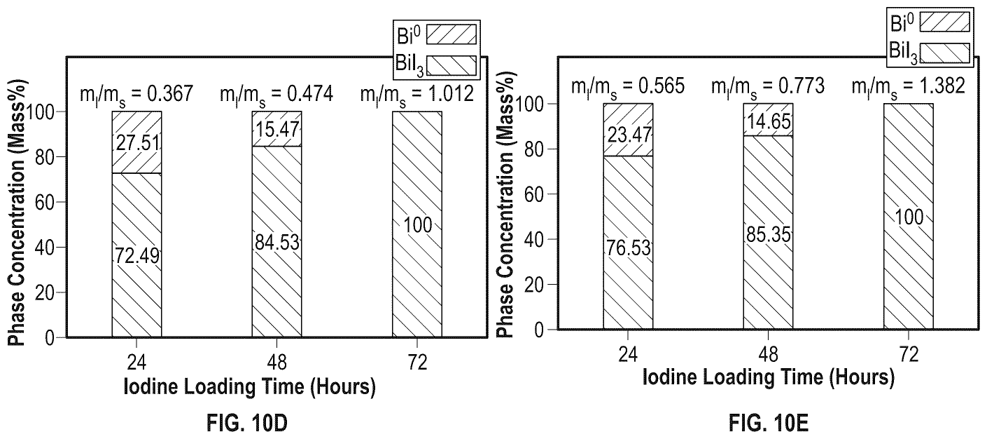

To better understand the kinetics of iodine reactions with the Bi-PAN and Bi-Particle sorbents, 24-h and 72-h tests were conducted at 120±1° C. After the 72-h of iodine loading, based on XRD data, all Bi⁰ in the Bi-PAN composites and the Bi-Particle materials were fully converted to BiI₃ based on XRD data and the Qₑ values were increased to 1.012 (72 h) from 0.474 (48 h) g/g and to 1.382 (72 h) from 0.773 (48 h) g/g, respectively (see Table 2 and FIGS. 10A-E). Full conversion to iodine-containing compounds for Bi-PAN was slower compared to the other metal-PAN composites, and similar result was observed with Bi⁰ particles. FIG. 10B shows that, based on mass alone (i.e., expected BiI₃ formation), not all of the Bi⁰ was fully reacted to form BiI₃. FIG. 10C c shows the differences in Qₑ values for the Bi-PAN composites and the Bi-Particle samples and the offset between these datasets is attributed to the PAN binder dropping the overall mₘ values on a mₛ basis.

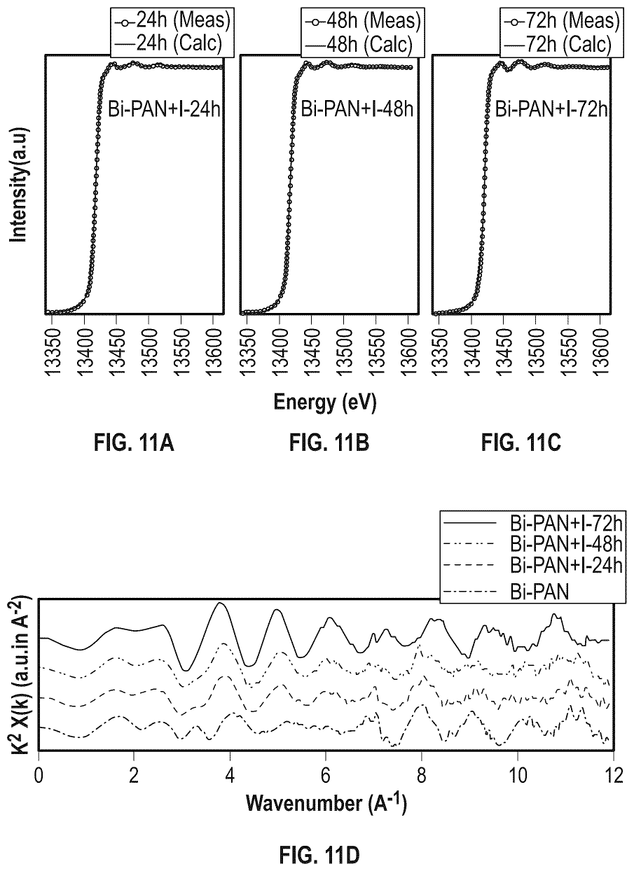

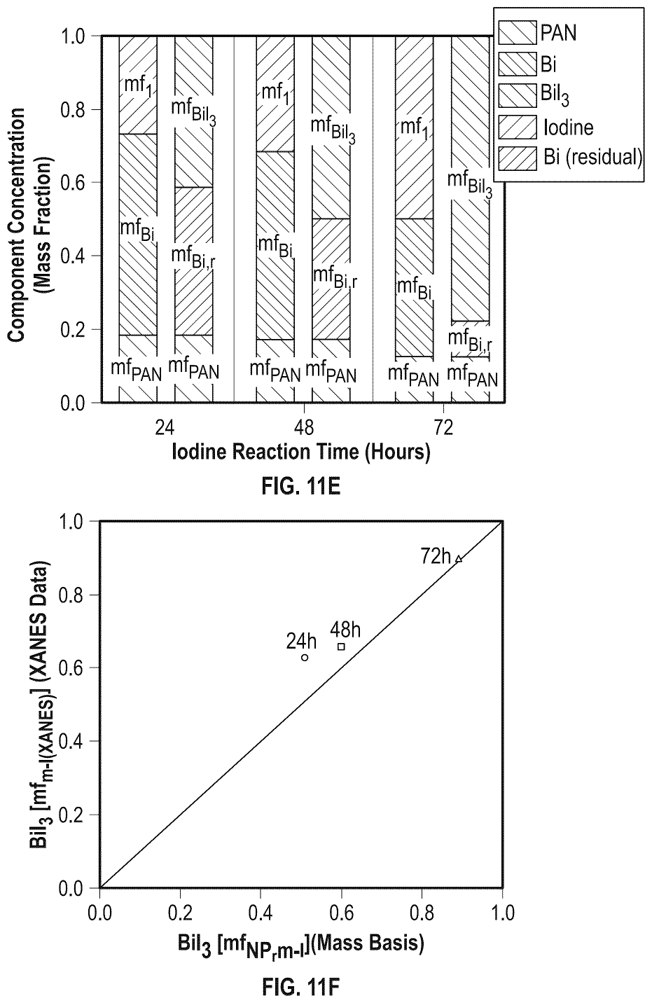

FIGS. 11A-C show the XANES data for the Bi-PAN+I composite sorbents over different iodine exposure times of 24 h, 48 h, and 72 h and FIG. 11D shows the extended X-ray absorption fine structure (EXAFS) for iodine-loaded Bi-PAN composites as well as Bi-PAN (without iodine). FIG. 11D provides the ability to see the minor fluctuations in the peaks that are associated with the Bi speciation within these samples. FIG. 11E provides comparisons of the phase distributions within the different Bi-PAN+I composites in terms of mass fractions of the different components present in the sorbents. It should be noted that the same mass of PAN was added to all metal-PAN composites but the total mass fraction (mfᵢ of phase “i”) of PAN drops in the iodine-loaded metal-PAN composites as the iodine content (and therefore m_{s+I} increases. The iodine L₃-edge XANES data do not reveal enough information to discern between the different iodine bonding environments in the Bi-PAN+I composites, BiI₃, and BiOI.

FIG. 11F provides a comparison between the BiI₃ concentration based on the mass fraction of BiI₃ in the Bi-PAN+I composites mf_{BiI3} calculated using Equation (1-15) [mass basis or mf_{NP,m-I}] and the XANES fitting data [mf_{BiI3} (XANES)], which was converted to a mass basis from the molar concentrations calculated with Equation (1-16). Additionally, the iodine L₃-edge XANES data for the Bi-PAN+I composites, BiOI, and BiI₃ look very similar on a qualitative basis suggesting very similar bonding environments for iodine amongst these species.

Aqueous Testing with Metal-PAN Composites

Iodine capture in the aqueous simulant was not successful. Over the course of the 24 h batch test, the PAN composites were not able to effectively capture iodine-127 (i.e., ¹²⁷I⁻). It was noticed that the metal-PAN composites changed density during the test, where they initially settled to the bottom of the container, but after 24 h of testing, they rose and floated at the top of the solution. More data is needed to understand why these do not work for iodide capture.

### Discussion

The method of dropping the DMSO-PAN solutions containing metal particles into water instantly freezes the initial droplet shape into final bead morphology. Allowing the beads to sit in the DIW solution draws out the DMSO from the bead interiors through passive diffusion. To further remove DMSO, the beads were placed in fresh DIW baths to help drive the diffusion process by maintaining the concentration gradient. It is likely that different polymers could be implemented in a similar technique, but PAN was selected based on success of implementing this same process to create other hybrid sorbents.

When looking at the iodine loadings for all sorbents in this study, none of the sorbents show full reaction (C % m<100) of the metal to a MIₓ compound based solely on a mass gain basis, although several sorbents do show very high C % m values. These data are in contradiction with the XRD results provided in Table 3 and FIGS. 9A-D and this is why some of these other calculations were performed such as the residual metal present in the sorbents (m_{m,r}) solely based on the mass of metal present in the sorbents (mₘ) at the start of the iodine-loading experiments. When looking at the comparisons of XRD data with the mass basis data (excluding m_{PAN} in the sorbents), the data show some irregularities where XRD showed far less residual metal present and much higher metal-iodide conversions. The actual cause(s) for the discrepancies is(are) unclear but could be related to non-crystalline metal being present in the iodine-loaded sorbents or crystalline metallic particles being present below XRD detection limits, although these do not seem very plausible due to the high fractions calculated on a mass basis.

The data in FIG. 11F align well, but a caveat to these calculations is that the fitting routine used for XANES data showed that some BiOI could be present whereas the calculation to determine mf_{NP,m-I} purely on a mass uptake basis did not assume the formation of any BiOI and attributes all mass uptake as iodine to form BiI₃. This approach was taken during data analysis because no BiOI was observed in the XRD analyses of the Bi-based sorbents (see Table 3). The residual Bi values present in the samples based on mass data mf_{NP,m,r} and XANES data mf_{Bi,r} (XANES) provide evidence that not all of the Bi⁰ reacted to form BiI₃ (or other compounds like BiOI). More work is needed to fully elucidate the underlying causes for incomplete metal utilization in these sorbents. Several assumptions were made to achieve the values from these calculations and the main assumption is based on the purities of the starting metal particles where it is possible that they are not as pure as stated by the vendor.

In a previous study where pure metal wires were evaluated as potential sorbents for I₂(g), Ag⁰, Cu⁰, and Sn⁰ were identified as promising candidates from several perspectives including the I₂(g) affinity as well as the capture kinetics, and this study was a follow up study to that by implementing pure metal particles into semi-porous polymer beads. In addition to these metals, Bi0 has emerged as a promising I₂(g) getter in other recent studies as well, so it was included in this study for comparison. More work is needed to understand the correlations (if any) between the initial metal particle sizes and morphologies with the iodine capture potential under different conditions (e.g., iodine centration, temperature, oxidizing conditions). Since each particle used in this study varied in size and morphology, the iodine capture data does not appear to align well with the PSDs of the initial metal particles. A caveat to this comparison is that the iodine-to-metal molar ratios (M_{I} values) in the iodine-loaded materials are very different for each metal so this needs to be considered when comparing the performances of these dissimilar metals. It is also unclear how large of metal particles could be implemented in a hybrid sorbent such as the metal-PAN composite design. A comparison study to evaluate the ideal sizes of metal particles for each specific metal would be a worthwhile follow-up effort and would bridge the current dataset with a previous study on 0.5-mm diameter metal wires.

The iodine loading capacities of PAN composites and metal particles from this study are compared to other chemisorption-based sorbents from previous studies where the Cu-PAN+I and Sn-PAN+I composites showed notably higher iodine loading capacities compared zeolites. This move from wires to utilizing metals with higher specific surface areas such as small particles, should help increase the interactions with the available metal surfaces in flowthrough systems but will likely never be as effective as using microporous and mesoporous substrates with embedded nanosized getters such as the metal-exchanged zeolites, aerogels, or xerogels. However, metal particles embedded in a porous matrix fall in the middle of these different candidate sets of materials where the getter availability is extremely high (i.e., 75 mass % in this study) and the pressure drop should be minimal in a packed bed of these types of bead-based sorbents that are mostly spherical in shape. It is likely that higher metal loadings can be achieved as well based on previous work involving synthesis of PAN-based composite beads.

Upon loading these sorbents with iodine, options exist for embedding them into a cement or grout for disposal (depending on the disposal environment requirements). It is also possible that the polymer binder could be burned off or dissolved away leaving behind a pure metal iodide available for hot pressing into a monolithic waste form with maximum waste loading.

Future work needs to include assessment of sorption kinetics to better understand why Bi⁰ behaves so differently from these other metals, requiring far longer times to achieve full conversion of the metal to the metal-iodide compound, BiI₃. More work is also needed to understand why these metals do not work for capturing I⁻ in caustic solutions. Being able to selectively pull ¹²⁹I⁻ out of caustic scrubber solution would be extremely valuable for nuclear cleanup applications.

In some cases, it might be possible (and desired) to recycle the getter metals for creating new sorbents and this would require stripping the iodine off the metals. One option for doing this for Ag-based sorbents is to soak them in Na₂S solution whereby the AgI dissociates, Ag converts to Ag₂S, and the iodine enters solution as I⁻ where it could be scavenged using an iodide getter. This appears to add unwanted complexity but does provide the option for recycling Ag, which is a precious metal and a hazardous material with disposal restrictions in the U.S. regulated by the Environmental Protection Agency under the Resource Conservation and Recovery Act (RCRA). It is unclear if similar options exist for recycling Bi-based, Cu-based, or Sn-based sorbents, but if these options did exist, it is unlikely that the benefits would outweigh the costs associated with these processes. Loading iodine into high-capacity sorbents such as metal-organic frameworks or conjugated microporous polymers provides more options for capture that also can have recycle options. At some point, the final fate of the captured radioiodine needs to be considered and the ideal binding site for iodine is likely as a metal iodide that is chemical stable in a repository environment.

### Summary and Conclusions

Four sets of metal-PAN composite beads containing 75 mass % of Ag⁰, Bi⁰, Cu⁰, and Sn⁰ (25 mass % PAN) were synthesized and tested for iodine loading capacities and these were compared to iodine capture with the initial metal particles (without PAN). The iodine loading capacities were in the range of Qₑ=0.474 to 1.669 g/g with Sn-PAN showing the highest Qₑ value (1.669 g/g) followed by Cu-PAN+I (1.457 g/g), Ag-PAN+I (0.753 g/g), and Bi-PAN+I (0.474 g/g) in descending order, after 48-hour loading tests at 120° C. For the 48-hr iodine loading tests, the Ag-PAN composite showed very high Ag utilization (C % m=85.4%) with lower values for Sn-PAN (C % m=52.0%) and Bi-PAN (C % m=34.7%) where all three showed lower iodine capture than the pure metal particles (C % m of 95%, 70%, and 42%, respectively). Interestingly, the Cu-PAN composites performed better (C % m=97%) than the pure metal particles (C % m=52%). For the Bi-PAN composites and Bi-Particles, iodine exposure times of 72 h showed metal utilization values of 74% and 76% (C % m), respectively, based on mass changes showing that the kinetics of adsorption are different for Bi⁰ than the other metals.

While these materials are very easy to make, scale-up could be challenging due to settling of the metal particles during the synthesis procedure likely leading to a large variation in metal loading distributions from bead to bead in a single batch. Also, the 75 mass % metal loading in these composites was an arbitrary loading selection and this could likely be increased substantially. It is unclear if the pressure drop would be too high if composites such as these were implemented in a packed column, but this should be evaluated in the future. Compared to the iodine loading capacities of zeolites, aerogels, and xerogels, the Sn-PAN and Cu-PAN composite sorbents showed higher Qₑ (m_{I}/mₛ) values by approximately 3× compared to aerogels and xerogels, and approximately 5× to 10× compared to zeolites (i.e., Ag-faujasite and Agmordenite). Solution-based capture with the metal-PAN composites did not show any iodide capture so more work should be done to evaluate performance of these sorbents at different pH values and ion competition environments.

### Example 2

The pellet making process was varied with this work depending on several variables being explored where different numbers of layers were included in pellets. For multi-layer pellets, the anvil and previously pressed layers were left in the cylinder, but the ramrod was removed for each subsequent pelletization layer being pressed. Sometimes the pressures differed between the different layers in multi-layer pellets.

To make pellets, several physical properties and parameters of each different phase were considered so that pellets of similar dimensions could be produced. Pellets were produced in similar sizes to start this process. The initial pellet sizes produced were ˜2.5 mm in height (h) and 10 mm in diameter (radius, r, of 5 mm) with an approximate green pellet volume (V_{p,g}) of 196.35 mm³ (0.19635 cm³) calculated using Equation (2-1). The method for calculating the total mass of material needed to achieve this target pellet volume included formulation in Microsoft Excel based off Equation (2-2) using the goal seek function to determine target masses of phase-a (mₚ₋ₐ; waste-containing material, i.e., ceramic or halide phase) and phase-b (m_{p-b}; encapsulant metal) to achieve a specific target waste loading in mass % (WLₘ %) utilizing the densities of each phase [Equation (2-3)], i.e., ρₚ₋ₐ and ρ_{p-b}, respectively.

$${V}_{p , g} = π {r}^{2} h \qquad ( 2 - 1 )$$

$${V}_{p , g} = {m}_{p - a} / {ρ}_{p - a} + {m}_{p - b} / {ρ}_{p - b} \qquad ( 2 - 2 )$$

$${m}_{p - a} / ( {m}_{p - a} + {m}_{p - a} ) \cdot 100 = {WL}_{m \%} \qquad ( 2 - 3 )$$

Once the phase-a and phase-b masses were determined, these were weighed out on an analytical balance (ME204E; Mettler Toledo, Columbus, OH; ±0.1 mg), mixed together on weight paper for 1 minute, and then loaded into the chamber of a 10-mm diameter steel die. The die was loaded into a uniaxial press (model 3393, Carver, Inc.), and a 1000 pounds per square inch (PSI) (3.1 metric tons) load was applied for 1 minute; for some pellets a 1500 PSI (5.0 metric tons) load was used on the gauge. After 1 minute of applied load, the load was released, and the pellet was recovered from the die. Using Equation (2-3) modified (corrected) from the original (MTI 2023), the actual applied load pressure (P_{A}) during this process was calculated where Tis the force applied (in metric tons) on the hydraulic cylinder, g is the acceleration due to gravity (9.8 m/s²), and r is the radius of the die (in m).¹ The other option is to divide the force applied (F_{A}) by the area of the die face (A_{d}) to get the applied pressure (P_{A}) as shown in Equation (2-4). ¹For a 1-cm diameter die (0.005-m radius) the P_{A} values for pellets pressed at 1000 PSI and 1500 PSI were calculated as 387 MPa and 624 MPa, respectively.

$${P}_{A} = ( T \cdot g ) / ( π {r}^{2} ) \qquad ( 2 - 4 )$$

$${P}_{A} = {F}_{A} / {A}_{d} \qquad ( 2 - 5 )$$

Once the pellets were removed from the die, the green pellet masses (m_{p,g}) were taken and the V_{p,g} was calculated using calipers where a few different measurements were taken of the diameter and the thickness so that averages could be calculated. After pellets were prepared, they were heat treated for different temperatures, different times, and in different atmospheres and these details are provided in Table 2-1.

TABLE 2-1
Summary of processing details for two-phase pellets where phase-a is the material to be encapsulated
and phase-b is the encapsulant phase (metal), h is the target pellet thickness (height), Atm is the
atmosphere (air or vacuum), Tₕₜ is the heat treatment temperature, tₕₜ
is the heat treatment time, Ramp is the ramp rate used for some of the pellets, WL_{I, m}
is the expected mass loading of iodine in the composite waste form, and WL_{MI, v}
is the expected volumetric loading of the MIₓ compound in the final composite.

| | | | | | | | | Ramp | WL_{I, m} | WL_{MI, v} |
|---|---|---|---|---|---|---|---|---|---|---|
| ID | Phase-a | Phase-b | h (mm) | mₚ (g) | Atm | Tₕₜ (° C.) | tₕₜ (h) | (° C./min) | (m %) | (vol %) |
| 1a | — | 100% Bi | 1.5 | | Air | 203 | 22 | 5 | — | — |
| 2a | — | 100% Bi | 2.5 | | Air | 203 | 8 | 5 | — | — |
| 2b | 10% Al₂O₃ | 90% Bi | 2.5 | | Air | 203 | 8 | 5 | — | — |
| 2c | 15% Al₂O₃ | 85% Bi | 2.5 | | Air | 203 | 8 | 5 | — | — |
| 3a | — | 100% Bi | 2.5 | | Vac | 203 | 22 | — | — | — |
| 3b | 15% AgI | 85% Bi | 2.5 | | Vac | 203 | 22 | — | 8.11 | 23.3 |
| 3c | 30% AgI | 70% Bi | 2.5 | | Vac | 203 | 22 | — | 16.22 | 42.5 |
| 4a | 30% CuI | 70% Bi | 2.5 | | Vac | 203 | 20 | — | 19.99 | 42.5 |
| 5a | 30% CuI | 70% BiSn | 2.5 | | Air | 104 | 8 | 5 | 19.99 | 39.3 |
| 5b | 30% AgI | 70% BiSn | 2.5 | | Air | 104 | 8 | 5 | 16.22 | 39.2 |

The calculations for making three-phase pellets (i.e., metal, polymer, and ceramic/halide phases) that included the PAN phase were more complicated as they assume the following: (1) an even metal loading across all metal-PAN composites, (2) an even iodine loading across all metal-PAN composites, (3) that no mass changes occurred after iodine loading (due to water absorption from the air), and (4) that the PAN does not decompose during the iodine loading process. Thus, similar equations to those above were used here with a few adjustments described below in more detail.

After loading the metal-PAN composites with iodine, not all of the metal reacts with iodine according to mass changes (before and after the iodine loading tests) alone. This means that some residual metal mass (m_{m,r}) remains in the beads and this has to be accounted for when calculating the overall composite volume after iodine loading (V_{polymet+I}), which is defined in Equation (2-6). The three components in this calculation include the PAN matrix (m_{PAN} and ρ_{PAN}), the metal-iodide (m_{MI}_{ₓ} and P_{MI}_{ₓ}), and the residual metal (m_{m,r} and ρ_{m,r}) where the desired masses of all components were calculated using the same goal seek function in Excel as mentioned in Section 3.5.1. From these calculations, the mass of iodine waste loading (WL_{I,m}) and volumetric waste loading of the MIₓ complex (WL_{MI,v}) can be calculated using Equation (2-7) and Equation (2-8), respectively, including the volume of the encapsulant metal phase (V_{m,e}).

$${V}_{polymet + I} = {m}_{PAN} / {ρ}_{PAN} + {m}_{{MI}_{x}} / {ρ}_{{MI}_{x}} + {m}_{m , r} / {ρ}_{m , r} = 0.19635 {cm}^{3} \qquad ( 2 - 6 )$$

$$W {L}_{I , m} = 100 \cdot {m}_{I} / ( {m}_{P A N} + {m}_{M {I}_{x}} + {m}_{m , r} ) \qquad ( 2 - 7 )$$

$$W {L}_{MI , v} = {V}_{M {I}_{x}} / ( {y}_{p o l y m e t + I} + {V}_{m , e} ) \qquad ( 2 - 8 )$$

For making the 3-phase pellets, a few different polymer-ceramic-metal (polycermet) composite ideas were evaluated.

Initial thin pellet layer. Pressing the polymer-containing phase in between different pure metal layers. To evaluate this option, work was done to look at how difficult it would be to press pellets that were <1 mm with the target thickness of ˜0.5 mm (500 μm). The pressing pressure for these thin discs was 1000 PSI (3.1 metric tons) on the Carver press gauge. This worked well so the next step was conducted.

Adding polymer-containing layer with metal filler (2-layer). Adding the polymer-containing layer was done by loading the MIₓ-PAN material on top of the thin bottom metal pellet, loading the metal powder in with the MIₓ-PAN material, and pressing at higher pressures on the Carver press (1500 PSI or 5.0 metric tons) gauge. When doing this, it was clear that the portions of the MIₓ-PAN remained uncovered by metal so it was decided that a top metal layer should be added in the subsequent 3^{rd} layer approach.

Adding a top metal layer to the 2-layer approach (3-layer). The 3-layer approach was done the same as the 2-layer approach, but after the 2-layer pellet was pressed, additional Bi particles were added to the die, and the mixture was pressed at 1000 PSI (3.1 metric tons).

No material grinding was performed when making the Set-6 pellets (Set-6b and Set-6c) whereas samples were ground to a finer particle size for Set-7 pellets (Set-7d and Set-7e). To do the grinding process, beads were placed between two weigh boats and crushed. This process prevents significant loss of material onto the surfaces of a mortar and pestle or due to samples jumping out of the container holding them during grinding. This method also allows for easy transfer of the crushed material afterwards since they are already in a weigh boat.

TABLE 2-2
Experimental details for 3-phase pellets. All pellets in this table were fired under vacuum at 203° C.

| | | | | | Phase-a | Phase-b | Phase-c | Phase-d | h | Tₕₜ | tₕₜ | WL_{I, m} | WL_{MI, v} |
|---|---|---|---|---|---|---|---|---|---|---|---|---|---|
| ID | Phase-a | Phase-b | Phase-c | Phase-d | mass (g) | mass (g) | mass (g) | mass (g) | (mm) | (° C.) | (h) | (m %) | (vol %) |
| 6a | 100% | — | — | — | 0.3838 | 0 | 0 | 0 | 0.560 | 203 | 22 | — | — |
| | Bi | | | | | | | | | | | | |
| 6b | 100% | AgI- | 100% | — | 0.3948 | 0.1112 | 0.6337 | 0 | 1.830 | 203 | 22 | 4.47 | 13.64 |
| | Bi | PAN | Bi | | | | | | | | | | |
| | | (a) | | | | | | | | | | | |
| 6c | 100% | AgI- | 100% | 100% | 0.3835 | 0.1274 | 0.6288 | 0.3834 | 2.545 | 203 | 22 | 3.80 | 11.67 |
| | Bi | PAN | Bi | Bi | | | | | | | | | |
| | | (a) | | | | | | | | | | | |
| 7a | 100% | — | — | — | 0.3842 | — | — | — | 0.530 | 203 | 20 | — | — |
| | Bi | | | | | | | | | | | | |
| 7b | 100% | — | — | — | 0.3072 | — | — | — | 0.465 | 203 | 20 | — | — |
| | Bi | | | | | | | | | | | | |
| 7c | 100% | — | — | — | 0.2308 | — | — | — | 0.357 | 203 | 20 | — | — |
| | Bi | | | | | | | | | | | | |
| 7d | 100% | CuI- | 100% | 100% | 0.2310 | 0.1889 | 0.4125 | 0.2312 | 2.160 | 203 | 20 | 10.45 | 23.81 |
| | Bi | PAN | Bi | Bi | | | | | | | | | |
| | | (b) | | | | | | | | | | | |
| 7e | 100% Bi | AgX + I | 100% | 100% Bi | 0.2303 | 0.2064 | 0.4154 | 0.2309 | 1.930 | 203 | 20 | 4.48 | 25.41 |
| | | (c) | Bi | | | | | | | | | | |

What is claimed is:

1. A method comprising:
producing sorbent material that include one or more polymeric materials and one or more zero-valent metals;
capturing an amount of radioactive iodine using the sorbent material to produce iodine-loaded sorbent; and
encapsulating the iodine-loaded sorbent in one or more metallic materials.

2. The method of claim 1, comprising:
combining an amount of one or more solvents with an amount of the one or more polymeric materials to produce a first solution; and
providing one or more metal particles including the one or more zero-valent metals to the first solution to produce a second solution.

3. The method of claim 2, wherein the one or more solvents include at least one of dimethyl sulfoxide (DMSO), dimethyl acetamide, dimethyl formamide, ethyl carbonate, sulfolane, or N-methylpyrrolidone.

4. The method of claim 2, wherein a ratio of volume of the one or more solvents to mass of the one or more polymeric materials is from about 12 mL of the one or more solvents/1 g of the one or more polymeric materials.

5. The method of claim 2, wherein:
the amount of the one or more zero-valent metals present in the second solution is from about 70% by mass to about 90% by mass with respect to the mass of the one or more polymeric materials and the mass of the one or more metal particles combined; and
the amount of the one or more polymeric materials present in the second solution is from about 10% by mass to about 30% by mass with respect to the mass of the one or more polymeric materials and the mass of the one or more metal particles combined.

6. The method of claim 1, wherein:
the one or more polymeric materials include polyacrylonitrile; and
the one or more zero-valent metals comprise at least one of Ag⁰ particles, Bi⁰ particles, Cu⁰ particles, or Sn⁰ particles.

7. The method of claim 2, comprising:
removing an amount of the second solution from a container; and
providing the amount of the second solution to a third solution located in an additional container to form at least a portion of the sorbent material.

8. The method of claim 7, wherein the third solution comprises water at a temperature from about 1° C. to about 30° C.

9. The method of claim 1, comprising:
contacting the sorbent material with a stream comprising radioactive iodine to produce the iodine-loaded sorbent, the iodine-loaded sorbent including one or more metal iodides and the one or more polymeric materials, wherein the one or more metal iodides are comprised of iodine from the stream and the one or more zero-valent metals; and
wherein the radioactive iodine is gaseous iodine present in one or more waste streams produced by nuclear fission reactions.

10. The method of claim 9, comprising:
providing the iodine-loaded sorbent to a container; and
contacting the iodine-loaded sorbent with one or more additional solvents in the container to produce modified iodine-loaded sorbent, wherein the modified iodine-loaded sorbent has an amount of the one or more polymeric materials that is less than an initial amount of the one or more polymeric materials present in the iodine-loaded sorbent; and
wherein the one or more additional solvents include at least one of DMSO, dimethyl acetamide, dimethyl formamide, ethyl carbonate, sulfolane, or N-methylpyrrolidone.

11. The method of claim 10, wherein an amount of the one or more polymeric materials remaining in the iodine-loaded sorbent with the one or more additional solvents is no greater than about 50% of the initial amount of the one or more polymeric materials present in the iodine-loaded sorbent.

12. The method of claim 1, wherein the one or more metallic materials used to encapsulate the iodine-loaded sorbent include at least one of Bi particles, Sn particles, Bi—Sn alloy particles, or Bi—Pb alloy particles.

13. The method of claim 1, comprising:
providing the iodine-loaded sorbent and the one or more metallic materials to an apparatus that applies at least one of heat or pressure to the iodine-loaded sorbent and the one or more metallic materials to produce encapsulated sorbent; and
wherein the apparatus is a die and the apparatus produces the encapsulated sorbent in a form of pellets having diameters from about 5 mm to about 10 mm having heights from about 1 mm to about 3 mm.

14. The method of claim 13, comprising:
applying heat to the iodine-loaded sorbent and the one or more metallic materials within the apparatus at temperatures from about 100° C. to about 300° C.; and
applying a pressure-inducing device to the iodine-loaded sorbent and the one or more metallic materials within the apparatus at pressures from about 10 megapascals (MPa) to about 700 MPa.

15. The method of claim 13, wherein the encapsulated sorbent comprises from about 70% by mass to about 90% by mass of the one or more metallic materials and from about 10% by mass to about 30% by mass of one or more materials included in the iodine-loaded sorbent.

16. An article comprising:
a first component comprising one or more polymeric materials; and
a second component disposed within the first component, the second component comprising one or more zero-valent metals and the one or more zero-valent metals including at least one of Ag⁰ particles, Bi⁰ particles, Cu⁰ particles, or Sn⁰ particles.

17. The article of claim 16, wherein the one or more polymeric materials include polyacrylonitrile.

18. The article of claim 16, wherein the article has a body having a bead-like shape and the body has a diameter from about 0.5 mm to about 4 mm.

19. An article comprising:
a first component including one or more metal iodide compounds; and
a second component encapsulating the first component, the second component including one or more metallic materials.

20. The article of claim 19, wherein:
the one or more metal iodide compounds include at least one of AgI, CuI, BiOI, BiI₃, SnI₄, or SnI₂; and
the one or more metallic materials include at least one of Bi particles, Sn particles, Bi—Sn alloy particles, or Bi—Pb alloy particles.
